(19) United States
(12) Patent Application Publication
(10) Pub. No.: US 2025/0373737 A1
(43) Pub. Date: Dec. 4, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: ASAMI ITO, Kanagawa (JP)

(21) Appl. No.: 19/188,117

(22) Filed: Apr. 24, 2025

(30) Foreign Application Priority Data
May 31, 2024 (JP) 2024-089035

(51) Int. Cl. H04N 1/00

(52) U.S. Cl. CPC H04N 1/00029; H04N 1/00074; H04N 1/00209; H04N 1/00244; H04N 2201/0094

(57) ABSTRACT

Provided is an information processing apparatus for processing transmission jobs for transmitting electronic mail, including: a setting unit configured to set, in advance, a value of a parameter to be used in communication with a mail server for executing the transmission jobs; an execution unit configured to execute the transmission jobs with the set value of the parameter; a diagnosis unit configured to perform a diagnosis on the transmission job which failed to be executed among the transmission jobs executed by the execution unit by communicating with the mail server with a value of the parameter different from the set value of the parameter; and an identification unit configured to identify a cause of the failure of execution of the transmission job based on the diagnosis performed by the diagnosis unit.

### BACKGROUND

### Field of the Technology

The present disclosure relates to a process of diagnosing a job.

### Description of the Related Art

There are image forming apparatuses capable of performing processes such as image printing, image emailing, and image faxing. In a case where such an image forming apparatus performs any of those processes, a problem may occur such as the occurrence of an error or the output product not meeting the expectation. In a case where such a problem occurs and the user is unable to solve it on their own, they need to, for example, contact a call center or request a service engineer to come over to solve the problem. Thus, it takes time to solve the problem.

Japanese Patent Laid-Open No. 2017-174171 discloses a method in which, in case of a mutual connection error occurring between a multi-function peripheral and another multi-function peripheral, a solution to the connection error is displayed on a display unit. Displaying a solution on a display unit as in Japanese Patent Laid-Open No. 2017-174171 allows the user to solve the problem by themselves.

However, there can be multiple candidates of the cause of the error, in which case individual solutions for each of the multiple possible candidates of the cause of the error may be displayed in the method of Japanese Patent Laid-Open No. 2017-174171. Thus, in a case where there are many candidates of the cause of the error, the user needs to try all of the displayed solutions one by one, which places a burden on the user. SUMMARY

An information processing apparatus for processing transmission jobs for transmitting electronic mail, including: a setting unit configured to set, in advance, a value of a parameter to be used in communication with a mail server for executing the transmission jobs; an execution unit configured to execute the transmission jobs with the set value of the parameter; a diagnosis unit configured to perform a diagnosis on the transmission job which failed to be executed among the transmission jobs executed by the execution unit by communicating with the mail server with a value of the parameter different from the set value of the parameter; and an identification unit configured to identify a cause of the failure of execution of the transmission job based on the diagnosis performed by the diagnosis unit.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating a configuration of a system;

FIG. 2 is a diagram illustrating a hardware configuration of a controller unit of an image forming apparatus;

FIG. 3 is a block diagram illustrating a functional arrangement of the controller unit of the image forming apparatus;

FIG. 4 is a sequence chart for describing a flow of processing of a mail transmission job;

FIGS. 5A to 5E are diagrams illustrating an example of screens that are displayed on a touch panel of the image forming apparatus;

FIG. 6 is a sequence chart for describing a comparative example of an error diagnosis;

FIGS. 7A and 7B are diagrams illustrating an example of a job log screen;

FIGS. 8A and 8B are diagrams illustrating an example of a device operational status screen;

FIGS. 9A and 9B are diagrams illustrating an example of an error diagnosis result screen;

FIG. 10 illustrates a sequence chart for describing processing in a case of performing an error diagnosis and an additional diagnosis;

FIGS. 11A to 11D are diagrams illustrating an example of screens that are displayed on the touch panel of the image forming apparatus;

FIGS. 12A and 12B are diagrams illustrating an example of screens that are displayed on the touch panel of the image forming apparatus;

FIGS. 13A and 13B are a sequence chart and a flowchart for describing an additional diagnosis;

FIGS. 14A and 14B are a sequence chart and a flowchart for describing an additional diagnosis;

FIGS. 15A and 15B are a sequence chart and a flowchart for describing an additional diagnosis;

FIGS. 16A and 16B are a sequence chart and a flowchart for describing an additional diagnosis;

FIG. 17 is a diagram illustrating an example of a screen that is displayed on the touch panel of the image forming apparatus;

FIGS. 18A and 18B are diagrams illustrating an example of screens that are displayed on the touch panel of the image forming apparatus;

FIG. 19 is a diagram illustrating an example of a screen that is displayed on the touch panel of the image forming apparatus;

FIG. 20 is a diagram illustrating an example of a screen that is displayed on the touch panel of the image forming apparatus; and

FIGS. 21A to 21C are diagrams illustrating an example of screens that are displayed on the touch panel of the image forming apparatus.

### DESCRIPTION OF THE EMBODIMENTS

Embodiments of the technique of the present disclosure will now be described based on the drawings. Not all of the features described in the following embodiments are necessarily essential for the solution to be provided by the technique of the present disclosure. The following embodiments will each describe a method in which an image forming apparatus performs a diagnosis on a problem (error) that occurred during the execution of a job and, in a case where a further diagnosis is necessary, performs an additional diagnosis by connecting to a server with a changed parameter. The following embodiments exemplarily assume that a “job” is a mail transmission job and that a “problem” is a failure to transmit mail but is not limited to a problem in mail transmission.

### Embodiment 1

### System Configuration

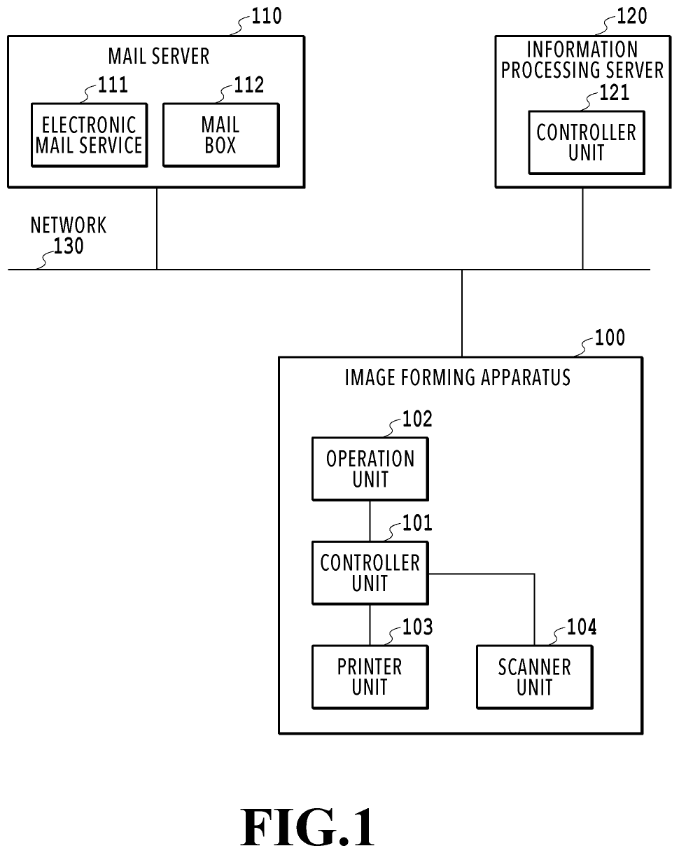

FIG. 1 illustrates an example of a system configuration in Embodiment 1. A system in the present embodiment includes an image forming apparatus 100 and a mail server 110. The image forming apparatus 100 and the mail server 110 are connected to each other through a network 130. In the present embodiment, the network 130 may be a wireless connection or a wired connection. Note that, in the present embodiment, an information processing server 120 illustrated in FIG. 1 does not necessarily need to be included in the system.

The image forming apparatus 100 is an information processing apparatus implemented with a multi-function peripheral (MFP) having multiple functions such as printing, scanning, and faxing, or the like. The image forming apparatus 100, for example, scans images with a scanner, prints images with a printer, and transmits and receives mail via the mail server 110. The image forming apparatus 100 has an operation unit 102 that receives inputs from and presents outputs to a user, a printer unit 103 that outputs electronic data onto paper media, and a scanner unit 104 that scans paper media and converts them into electronic data. The operation unit 102, the printer unit 103, and the scanner unit 104 are connected to a controller unit 101 and implements functions of a multi-function peripheral under control of the controller unit 101. The operation unit 102 functions as a display unit that displays user interface (UI) screens and as an input unit that accepts user inputs. For example, the operation unit 102 includes a display unit with a touch panel function, physical buttons, and so on.

The mail server 110 has an electronic mail service 111 and a mailbox 112. The electronic mail service 111 provides a function of transmitting electronic mail complying with the Simple Mail Transfer Protocol (SMTP) specified in RFC 5321 in response to receiving an instruction from the image forming apparatus 100. The electronic mail service 111 provides a function of receiving mail saved in the mailbox 112 in compliance with the POP specified in RFC 5034 and the IMAP specified in RFC 3501 in response to receiving an instruction from the image forming apparatus 100. POP stands for Post Office Protocol, and IMAP stands for Internet Message Access Protocol.

FIG. 1 illustrates a configuration for describing the technique of the present disclosure. Thus, components other than those in FIG. 1 may be included and the form of connection between the components is not limited to that in FIG. 1, as long as the technique of the present disclosure can be implemented.

### Hardware Configuration of Controller Unit

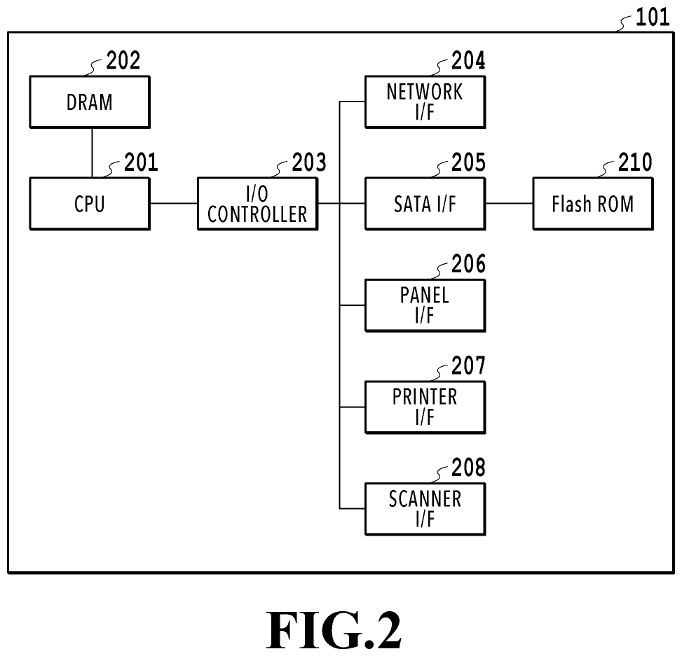

FIG. 2 is a block diagram illustrating a hardware configuration of the controller unit 101 of the image forming apparatus 100. The controller unit 101 is a control unit of the image forming apparatus 100 and is capable of causing the image forming apparatus 100 to function as an information processing apparatus or an image processing apparatus. The controller unit 101 has a central processing unit (CPU) 201, a dynamic random-access memory (DRAM) 202, an input-output (I/O controller) 203, a network interface (I/F) 204, a Serial Advanced Technology Attachment (SATA) I/F 205, a panel I/F 206. The controller unit 101 further has a printer I/F 207, a scanner I/F 208, a fax I/F 209, and a flash read-only memory (ROM) 210.

The CPU 201 is responsible to main arithmetic processing inside the controller unit 101.

The CPU 201 is connected to the DRAM 202 through a bus. The CPU 201 uses the DRAM 202 as a work memory to temporarily keep program data for the CPU 201 to give arithmetic instructions during computation, and data to be processed.

The CPU 201 is connected to the I/O controller 203 through a bus. The I/O controller 203 receives and sends information from and to various devices in accordance with instructions from the CPU 201. The SATA I/F 205 is connected to the I/O controller 203, and the flash ROM 210 is connected to the SATA I/F 205. The CPU 201 uses the flash ROM 210 to permanently store programs and document files for the image forming apparatus 100 to function as an image processing apparatus or an information processing apparatus. Instead of the flash ROM 210, a large-capacity storage apparatus, such as a hard disk drive (HDD), may be connected to the CPU 201.

The network I/F 204 is connected to the I/O controller 203, and a wired local area network (LAN) device or a wireless LAN device is connected to the network I/F 204. The CPU 201 controls the wired LAN device or the wireless LAN device via the network I/F 204 to implement communication over the network 130.

The panel I/F 206 is connected to the I/O controller 203. The CPU 201 enables reception of inputs from and presentation of outputs to the user on the operation unit 102 via the panel I/F 206. The CPU 201 operates as a display control unit that controls screens displayed on the touch panel of the operation unit 102 and as an operation control unit that controls user inputs into the operation unit 102. Note that while the present embodiment has been described on the assumption that the operation unit 102 including a display unit is present in the image forming apparatus 100, at least one of the display unit or the operation unit may be present as a separate apparatus outside the image forming apparatus 100.

The image forming apparatus 100 may be an apparatus that is remotely operable by an external apparatus, such as the information processing server 120.

Various applications for implementing various functions are present in the image forming apparatus 100. Examples of the functions to be implemented by the applications include a copy function, a mail transmission function, a fax function, a box function, and so on.

In a case of executing the copy function, the CPU 201 firstly detects a copy instruction from the user. To detect the copy instruction, the CPU 201 reads program data out of the flash ROM 210 via the SATA I/F 205 and loads it into the DRAM 202. Then, following the program loaded in the DRAM 202, the CPU 201 detects the copy instruction issued by the user operating the operation unit 102 via the panel I/F 206. In response to detecting the copy instruction, the CPU 201 causes the scanner unit 104 to read a document via the scanner I/F 208 and stores scanned image data of the document in the DRAM 202. The CPU 201 performs a color conversion process on the scanned image data stored in the DRAM 202 that makes the scanned image data ready to be output, or the like. The CPU 201 transfers the scanned image data stored in the DRAM 202 to the printer unit 103 via the printer I/F 207, and performs a process of outputting it onto a paper medium.

In a case of executing the mail transmission function, the CPU 201 firstly detects a mail transmission instruction from the user. The process for the CPU 201 to detect the mail transmission instruction from the user is the same as the process of detecting a copy instruction described above. The mail transmission instruction includes a transmission protocol, a designated transmission destination, an image format, and so on from the user. The transmission protocol is the Server Message Block (SMB), the File Transfer Protocol (FTP), mail (SMTP), or the like. The designated transmission destination is designated by the Universal Naming Convention (UNC), for example. The image format is the Joint Photographic Experts Group (JPEG) format, the Portable Document Format (PDF), or the like. In response to detecting the transmission instruction, the CPU 201 causes the scanner unit 104 to scan a document via the scanner I/F 208 and stores scanned image data of the document in the DRAM 202. The CPU 201 converts the scanned image data stored in the DRAM 202 into an image format designated by the user. The CPU 201 transfers the scanned image data stored in the DRAM 202 to a transmission destination (mail transmission) by a protocol designated by the user via the network I/F 204.

In a case of executing the fax function, the CPU 201 detects a fax instruction from the user. The process for the CPU 201 to detect the fax instruction from the user is the same as the process of detecting a copy instruction described above. In response to detecting the fax instruction, the CPU 201 causes the scanner unit 104 to scan a document via the scanner I/F 208 and stores scanned image data of the document in the DRAM 202. The CPU 201 performs an image format conversion for faxing and the like on the scanned image data stored in the DRAM 202. The CPU 201 transfers the scanned image data stored in the DRAM 202 to the telephone number of a fax machine designated in the fax instruction or the like through a telephone line network not illustrated or the like to which the fax I/F 209 is connected. The faxing through a telephone line is an example, and the faxing may be done through the Internet.

The box function is a function of saving image data obtained by scanning a document to a storage region in the image forming apparatus 100 or to a memory medium connected to the image forming apparatus 100. Also, with the box function, the image forming apparatus 100 can serve as a file server, making the image data saved in the image forming apparatus 100 accessible to external personal computers (PCs) not illustrated or other image forming apparatuses.

In a case of executing the box function, the CPU 201 firstly detects a box saving instruction from the user. The process for the CPU 201 to detect the box saving instruction from the user is the same as the process of detecting a copy instruction described above. The box saving instruction includes a designated saving destination, an image format, and so on from the user. The saving destination is a storage in the image forming apparatus 100 or a path to a memory medium connected to the image forming apparatus 100. The image format is JPEG, PDF, or the like. In response to detecting the box saving instruction, the CPU 201 causes the scanner unit 104 to scan a document via the scanner I/F 208 and stores scanned image data of the document in the DRAM 202. The CPU 201 converts the scanned image data stored in the DRAM 202 into an image format designated by the user. The CPU 201 transfers the scanned image data stored in the DRAM 202 to a saving destination designated by the user, such as the flash ROM 210 in the image forming apparatus 100 or a memory medium not illustrated, via the SATA I/F 205.

Note that the fax function may convert received image data into a format in which the image data is browsable on PCs and the like, instead of printing the received image data, and save the converted image data to a box. With the box function, the image forming apparatus 100 can serve as a file server, such as an SMB server, and make the contents in the flash ROM 210 accessible. The box function allows the CPU 201 to detect a box access instruction from the outside via the network I/F 204. The box access instruction includes an image file path in an access destination, and so on. The CPU 201 transfers image data stored in the flash ROM 210 corresponding to the designated image file path to the requestor of the box access instruction via the network I/F 204.

### Functional Arrangement of Controller Unit

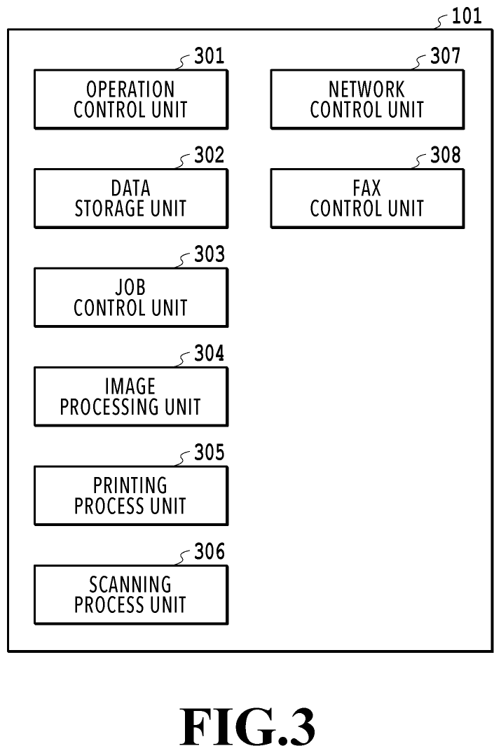

FIG. 3 is a block diagram illustrating a functional arrangement implemented by the controller unit 101 of the image forming apparatus 100. The controller unit 101 has an operation control unit 301, a data storage unit 302, a job control unit 303, an image processing unit 304, a printing process unit 305, a scanning process unit 306, a network control unit 307, and a fax control unit 308 as its functional units.

The operation control unit 301 performs display control for displaying UI screens for the user on the touch panel of the operation unit 102. Also, the operation control unit 301 detects user operations on the operation unit 102 and executes processes associated with screen elements, such as buttons, displayed in the UI screens.

The data storage unit 302 stores and reads requests from other functional units into and out of the flash ROM 210.

The job control unit 303 controls the execution of jobs in accordance with instructions from other functional units. For example, in a case of executing a mail transmission job, the job control unit 303 functions also as a setting unit that sets the values of parameters to be used in the communication with the mail server 110 in advance.

The image processing unit 304 processes image data into a suitable format on a use-by-use basis in accordance with an instruction from the job control unit 303.

The printing process unit 305 prints an image on a paper medium via the printer I/F 207 in accordance with an instruction from the job control unit 303 and outputs the paper medium.

The scanning process unit 306 scans a set document via the scanner I/F 208 in accordance with an instruction from the job control unit 303.

The network control unit 307 receives and sends data through a LAN, a Wi-Fi network, or a public line network via the network I/F 204 in accordance with instructions from functional units. Also, the network control unit 307 renders the data stored in the flash ROM 210 accessible to the data storage unit 302 from an external device. Image data in PDF, JPEG, or the like is an example of the data stored in the flash ROM 210.

The fax control unit 308 obtains received fax data from the network control unit 307, and performs a reception process on the obtained fax data in accordance with an instruction from the job control unit 303. The fax control unit 308, for example, causes the printing process unit 305 to perform a printing process on the fax data subjected to the reception process, or converts the fax data into image data in PDF, JPEG, or the like and stores the converted data in the data storage unit 302. The fax control unit 308 transmits image data scanned by the scanning process unit 306 as fax data via the network control unit 307.

While each functional unit in FIG. 3 is implemented by the CPU 201 loading a predetermined program stored in the flash ROM 210 to the DRAM 202 and executing it, the configuration is not limited to this. In an alternative example, hardware such as a graphics processing unit (GPU) for speeding up computation or a field programmable gate array (FPGA) may be utilized. Each functional unit in FIG. 3 may be implemented by software and hardware, such as a dedicated integrated circuit (IC), cooperating with each other, or some or all of the functions may be implemented solely by hardware. Note that the functions implemented by the functional units in FIG. 3 are an example of the functions implemented by the controller unit 101 of the image forming apparatus 100, and may include other functions.

### Sequence of Mail Transmission Job

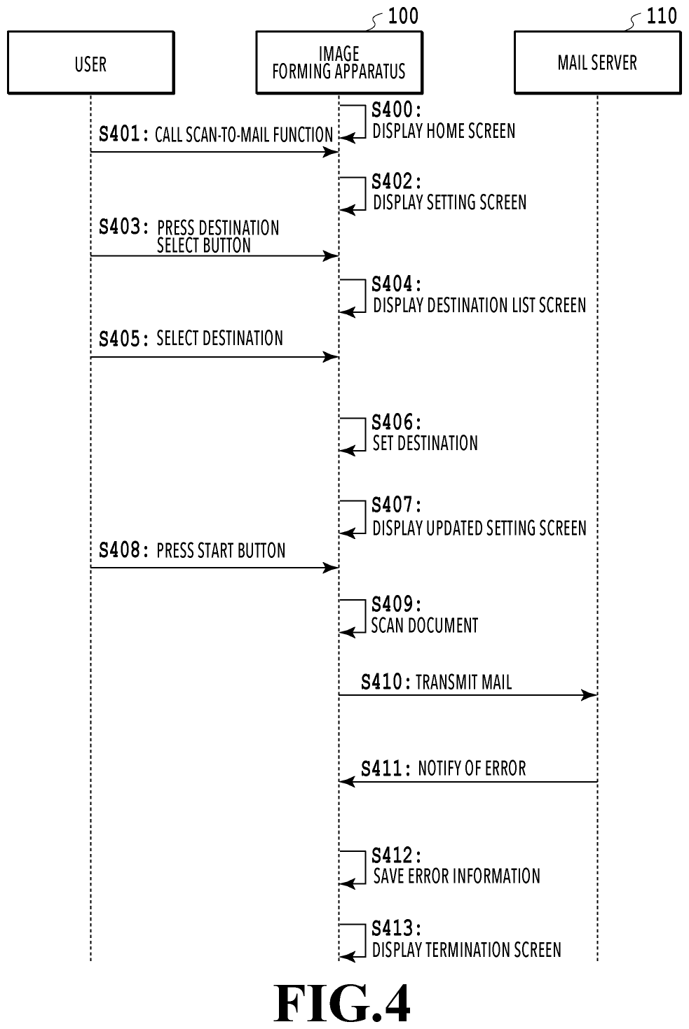

FIG. 4 is a sequence chart for describing a flow of processing between apparatuses in a case where the image forming apparatus 100 executes a mail transmission job but fails to transmit the mail due to a problem occurring during the mail transmission. The image forming apparatus 100 in the present embodiment has a function of diagnosing the failed job. In the following sequence, description will be omitted for operations during the occurrence of the problem that are not essential part of the present embodiment. A failing to execute a job, such as a failure to transmit mail, will also be expressed as the occurrence of an error.

The series of processes performed by the controller unit 101 in the following sequence chart or flowchart are performed by the CPU 201 of the controller unit 101 loading program code stored in the flash ROM 210 to the DRAM 202 and executing it. Alternatively, the functions of some or all of the steps in the following sequence chart or flowchart may be implemented by hardware such as an ASIC or an electronic circuit. The reference sign “S” in the description of each process in the following sequence chart or flowchart means one of these steps.

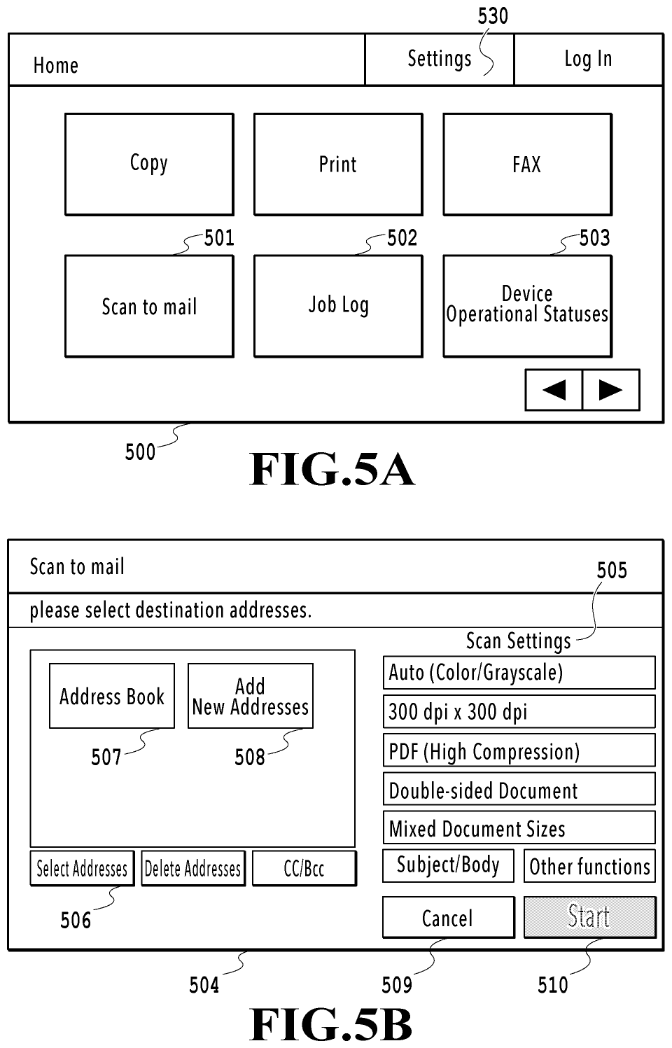

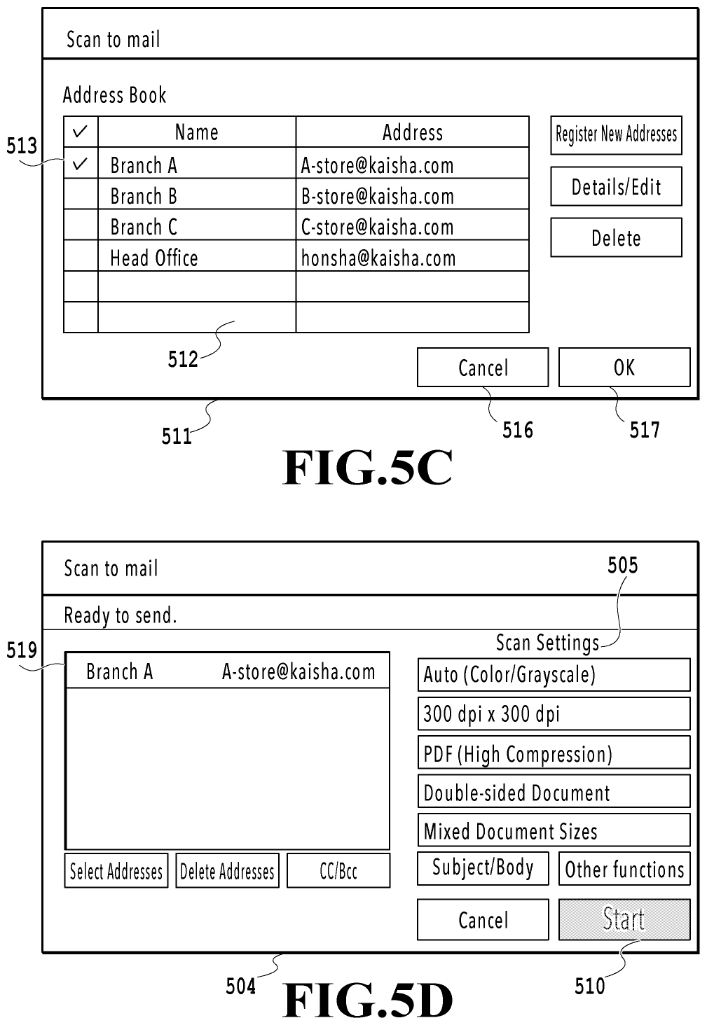

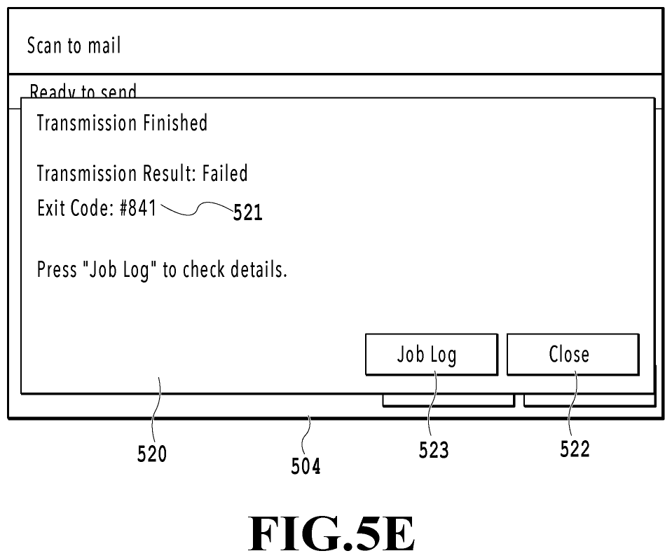

S400 is a process in a case where the image forming apparatus 100 is started, and the controller unit 101 performs a process of displaying a home screen 500 (see FIG. 5A) on the touch panel included in the operation unit 102 of the image forming apparatus 100.

FIGS. 5A to 5E are diagrams illustrating an example of screens displayed on the touch panel included in the operation unit 102. FIG. 5A is a diagram illustrating an example of the home screen 500. In the home screen 500, buttons for activating applications that execute the above-described functions, such as the copy function and the print function, are arranged. Incidentally, user authentication may be used to display the home screen 500 in a case where the user is authenticated. In the present embodiment, the process related to the user authentication will not be described for simple description.

In a case where the user presses a scan-to-mail button 501 in the home screen 500 in S401, the controller unit 101 detects the pressing of the scan-to-mail button 501. Then, in S402, the controller unit 101 displays a scan-to-mail setting screen 504 (see FIG. 5B) on the touch panel.

FIG. 5B is a diagram illustrating an example of the scan-to-mail setting screen 504. A scan setting region 505 is a region including setting items for the document scanning to be performed by the scanner unit 104, such as a color setting and a size setting. The user can select each setting item and select its setting value. The setting items included in the scan setting region 505 in FIG. 5B are an example, and other setting items than those displayed in FIG. 5B may be included. A destination selection button 506 is a button for selecting destinations. A cancel button 509 is a button that closes the scan-to-mail setting screen 504 to return to the home screen 500 in response to being pressed by the user.

A new entry button 508 is a button that allows the controller unit 101 to display a destination registration screen not illustrated in response to being pressed by the user. The user can register new destinations on the destination registration screen not illustrated. Description of an operation of registering a new destination is omitted.

A start button 510 is a button that executes a mail transmission job based on the selected scan settings in response to being pressed by the user. Details will be described later. Control is performed such that, in a case where the user has not yet selected a destination by pressing the destination selection button 506, the start button 510 is grayed out as illustrated in FIG. 5B so that pressing of the start button 510 by the user will not be accepted.

In S403, the user presses the destination selection button 506 and then an address book button 507, the controller unit 101 detects the address book button 507. Then, in S404, the controller unit 101 displays a destination list screen 511 (see FIG. 5C) on the touch panel.

FIG. 5C is a diagram illustrating an example of the destination list screen 511. In the destination list screen 511 is displayed a table 512 indicating a list of registered destinations whose communication protocol types registered in the image forming apparatus 100 are “mail.” Suppose, for example, that the user selects “A-store [0066]kaisha.com” associated with the name “Branch A” registered in a row 513 in the table 512. In this case, the controller unit 101 displays a check in the first column of the row 513 in the table 512 representing a list of destinations to indicate that the row 513 is selected. The user can select multiple destinations in the destination list screen 511. A cancel button 516 is a button that, in response to being pressed by the user, allows the controller unit 101 to perform a process of closing the destination list screen 511 without designating any destinations and returning to the scan-to-mail setting screen 504.

Suppose that, in S405, the user presses an OK button 517 with “A-store[0068]kaisha.com” in the row 513 in the destination list screen 511 selected. In this case, in S406, the controller unit 101 sets the selected destination “A-store[0069]kaisha.com” as a mail transmission destination.

In S407, the controller unit 101 displays an updated scan-to-mail setting screen 504 as illustrated in FIG. 5D such that information on the destination set in S406 is displayed in a transmission destination list 519.

If the user presses the start button 510 in the updated scan-to-mail setting screen 504 illustrated in FIG. 5D in S408, the controller unit 101 performs the processes of S409 and the subsequent steps. First, in S409, the controller unit 101 generates scanned image data that is electronic data of the document by causing the scanner unit 104 to scan the document based on the selected scan settings.

In S410, the controller unit 101 transmits mail with the scanned image data attached thereto to the mail server 110 in compliance with the SMTP protocol. As a result, the mail is transmitted to the destination selected by pressing the destination selection button 506. In S410, the mail is transmitted based on the values of parameters to be used in the communication with the mail server 110 set in advance by the job control unit 303.

S411 and S412 are processes in a case where the mail transmission in S410 fails due to an erroneous setting or another reason and an error occurs.

If the mail transmission in S410 fails, then in S411, the image forming apparatus 100 receives a notification indicating that an error has occurred (error notification) from the mail server 110 or the like.

In S412, the controller unit 101 determines error information from the contents of the error notification, and saves the error information as error information of the job executed in S409. The present embodiment will be described on the assumption that the error information is an error number representing information identifying an error (error identification information). The error number is a number assigned to an individual error notification based on its contents. In the present embodiment, the error number is displayed as an exit code.

For example, in a case where the image forming apparatus 100 initiates a Transmission Control Protocol (TCP) session, the mail server 110 may return a response with a rest (RST) flag (forcible termination) or there may be no response returned, resulting in a timeout. In this case, the error number is determined to be “#752.” That is, the error notification includes not only a notification from the mail server 110 but also a timeout notification. Also, there may be a case where a connection is established with the mail server 110 but the mail server 110 returns an Alert in response to the client hello. In this case, the contents of the Alert are analyzed, and the error number is determined to be “#841,” for example.

In S413, the controller unit 101 displays an exit screen 520 which notifies the user of the termination of the job (see FIG. 5E) on the touch panel.

FIG. 5E is a diagram illustrating an example of the exit screen 520 in the case where the mail transmission has failed. The result of the transmission is displayed in the exit screen 520 in FIG. 5E. In the case where the mail transmission has failed and an error has occurred, “Failed” is displayed as the transmission result. An exit code display region 521 displays the error number mentioned above as an exit code. In FIG. 5E, “#841” is displayed as an exit code. A job log button 523 will be described later. In a case where the user presses a close button 522, the controller unit 101 closes the exit screen 520 and displays the scan-to-mail setting screen 504.

### Error Diagnosis

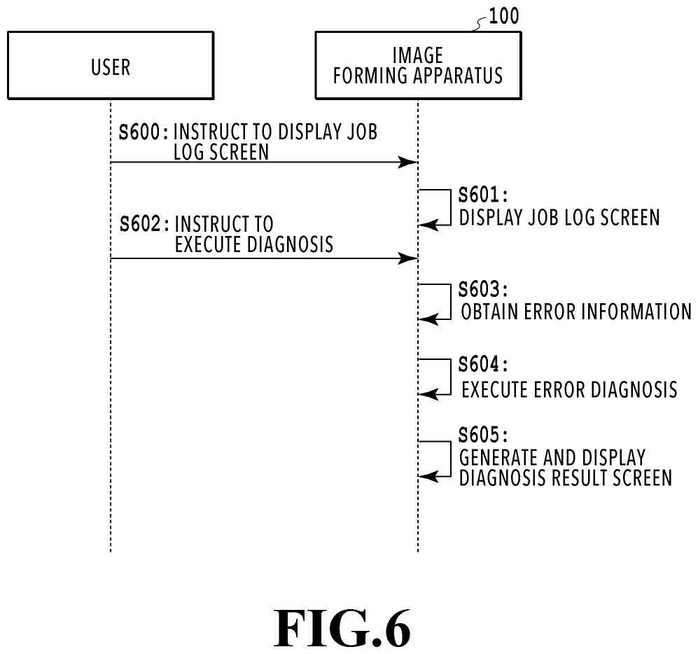

FIG. 6 is a sequence chart for describing processing between the user's operations and the image forming apparatus 100 up to a point where the controller unit 101 of the image forming apparatus 100 diagnoses the cause of failure of a job selected from a job log. This diagnosis will be referred to as “error diagnosis.”

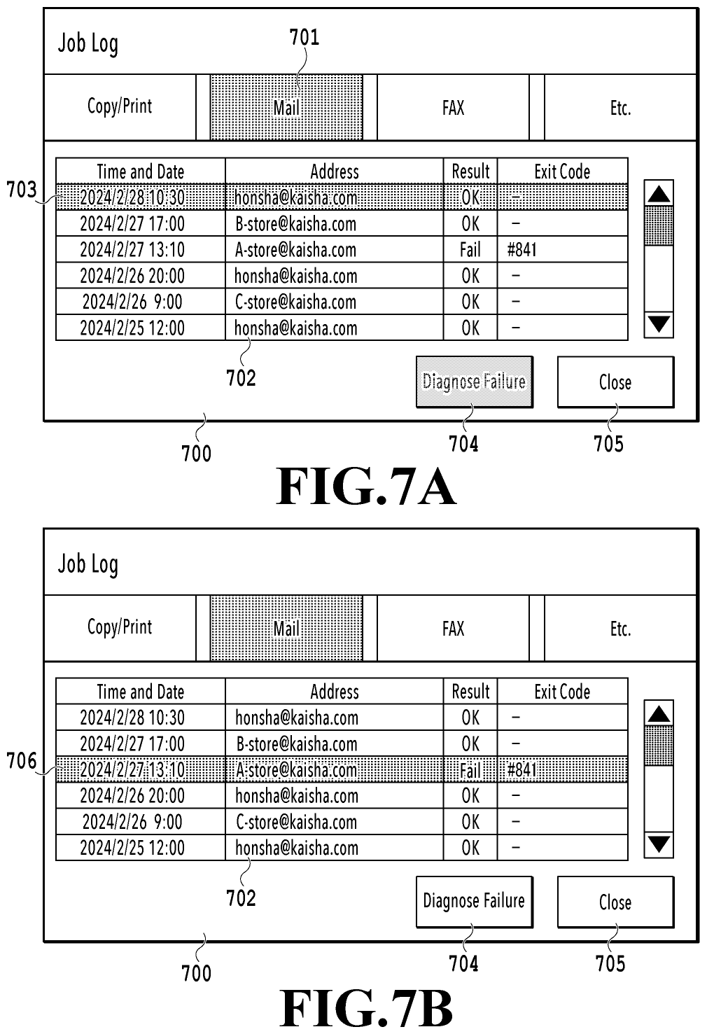

In S600, the user performs an operation to display a job log screen 700 (see FIGS. 7A and 7B) which is a screen for checking executed jobs. The job log screen 700 is a screen to be displayed in a case where the job log button 523 included in the exit screen 520 displayed in S412 is pressed. The job log screen 700 is also displayed in a case where a job log button 502 in the home screen 500 is pressed.

In S601, the controller unit 101 displays the job log screen 700 on the touch panel of the operation unit 102 in response to detecting the pressing of the job log button 523 or the job log button 502.

FIG. 7A is a diagram illustrating an example of the job log screen 700. The job log screen 700 is controlled to switch its display for each function, such as copying or printing, mail transmission, and fax transmission, and displays an executed job list corresponding to a selected function. For example, in a case where a mail button 701 is pressed, a job log list 702 including mail transmission jobs that were executed by the application with the mail transmission function is displayed in the job log screen 700. Each row in the job log list 702 displays information on an executed job. In FIG. 7A, as an example of the information on the executed job, “Date and Time” of the execution of the job, “Address” for the mail transmission, “Result” of the job, and “Exit Code” are displayed.

The job log list 702 in FIG. 7A displays the information on the executed jobs in descending order of date and time, but the executed jobs may be displayed in ascending order of date and time, for example. Also, the job information may include items that are not displayed in FIG. 7A. In a case where a close button 705 is pressed, the controller unit 101 performs a process of closing the job log screen 700 and returning to the home screen 500.

In S602, the user performs an operation for selecting a job in which an error occurred and issuing an instruction to execute an error diagnosis in which the controller unit 101 determines one or more candidates of the cause of the error that occurred during the execution of the selected job. The operation performed in S602 is, in a case where the job log screen 700 is displayed, selecting the row holding a job with “Failure” as “Result,” which is a job in which an error occurred, in the job log list 702 and pressing a failure diagnosis button 704. The job selected by the user in S602 will be referred to as “diagnosis target job” or “diagnosis target transmission job.”

The job log screen 700 in FIG. 7B illustrates an example in which a row 706 holding “2024 Feb. 27 13:10” as “Date and Time,” “A-store[0086]kaisha.com” as “Address,” “Failure” as “Result,” and “#841” as “Exit Code” is selected. In a case where the failure diagnosis button 704 is pressed in this state, the controller unit 101 obtains an instruction to execute an error diagnosis on the job corresponding to the row 706.

FIG. 7A illustrates an example in which a row 703 holding “2024 Feb. 28 10:30” as “Date and Time,” “honsha[0088]kaisha.com” as “Address,” “OK” as “Result,” and “-” as “Exit Code” is selected in the job log list 702. The job corresponding to the row 703 is not a job with “Failure” as “Result.” For this reason, the screen is controlled such that the user cannot issue an instruction to execute an error diagnosis on the selected job. For example, as illustrated in FIG. 7A, the screen is controlled such that the failure diagnosis button 704 is grayed out so that pressing of the failure diagnosis button 704 will not be accepted. That is, the screen is controlled such that the failure diagnosis button 704 can be pressed in a case where the row holding “Failure” as “Result” is selected in the job log list 702. In this way, in a case where the user selects a wrong row in the job log list 702, the user will recognize that the user has selected a wrong job.

The operation for issuing an instruction to execute an error diagnosis in S602 may be performed by a method other than the operation on the job log screen 700.

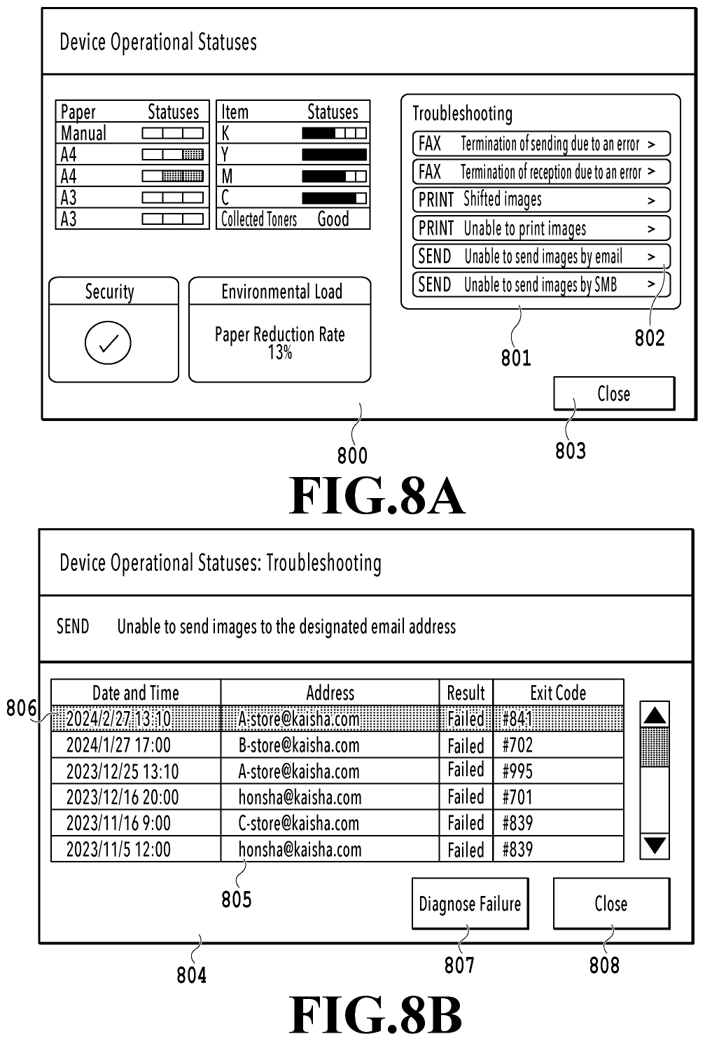

A device operational status screen 800 illustrated in FIG. 8A is a screen that is displayed on the touch panel of the image forming apparatus 100 in a case where the user presses a device operational status button 503 in the home screen 500. The device operational status screen 800 is a screen for displaying statuses of the image forming apparatus 100. A troubleshooting region 801 includes buttons for individual error categories, and the user presses buttons corresponding to the categories of errors which the user wishes to diagnose from among the buttons included in the troubleshooting region 801. For example, the user presses a button 802 displaying “Unable to send images by email” in a case where the user wishes to diagnose the cause of an error that occurred during mail transmission. In a case where the user presses a close button 803, the controller unit 101 closes the device operational status screen 800 and displays the home screen 500.

FIG. 8B is a diagram illustrating an example of a mail transmission troubleshooting screen 804 that is displayed in a case where the “Unable to send images by email” button 802 is pressed. In a case where the user presses a close button 808, the controller unit 101 performs a process of closing the mail transmission troubleshooting screen 804 and displaying the device operational status screen 800.

The mail transmission troubleshooting screen 804 includes a failed job log list 805 displaying a list of jobs in which errors occurred during mail transmission. Each row in the failed job log list 805 displays information on an executed job in which an error occurred during the execution of the job. In FIG. 8B, as an example of the information on the job, “Date and Time” of the execution of the job, “Address” for the mail transmission, “Result” of the job, and “Exit Code” are displayed. The failed job log list 805 in FIG. 8B displays the information on the executed jobs in descending order of date and time, but the executed jobs may be displayed in ascending order of date and time, for example. Also, the job information may include items that are not displayed in FIG. 8B.

The user operation in S602, which is an operation of issuing an instruction to execute an error diagnosis, may be an operation of selecting a row with a job on which the user wishes to perform an error diagnosis from among the rows in the failed job log list 805, and pressing a failure diagnosis button 807. For example, the failed job log list 805 includes a row 806 holding “2024 Feb. 27 13:10” as “Date and Time,” “A-store[0094]kaisha.com” as “Address,” “Failure” as “Result,” and “#841” as “Exit Code.” The job corresponding to this row 806 is the same as the job corresponding to the row 706 in FIG. 7B. Thus, the same instruction as that described with reference to FIG. 7B can be issued from the mail transmission troubleshooting screen 804 by selecting the row 806 in the failed job log list 805 and pressing the failure diagnosis button 807.

S603 is executed in response to receiving the instruction to execute an error diagnosis on the job selected by the user in S602. In S603, the controller unit 101 obtains error information (exit code) associated with the job selected by the user in S602 from the error information saved in S411.

In S604, the controller unit 101 executes an error diagnosis on the job selected by the user in S602, or the diagnosis target job.

For example, for each exit code, the controller unit 101 manages candidates of the cause of the error in advance. Also, for each candidate cause of the error, the controller unit 101 manages details of an action to be taken to handle the candidate cause. For this reason, in the error diagnosis, the controller unit 101 can determine candidates of the cause of the error associated with the exit code associated with the diagnosis target job selected by the user. Further, the controller unit 101 obtains the details of the actions to be taken to handle the candidates of the cause of the error thus determined. Thus, in the error diagnosis, the controller unit 101 determines candidates of the cause of the error based on information managed in the image forming apparatus 100, without having to communicate with the mail server 110.

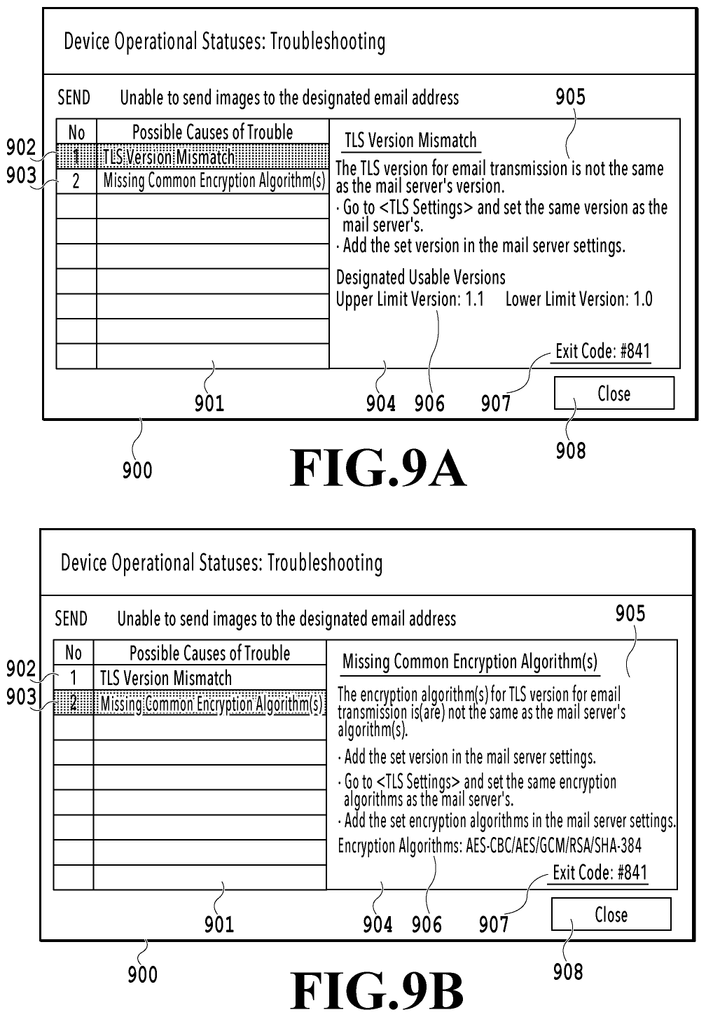

In S605, the controller unit 101 generates a diagnosis result screen 900 (see FIGS. 9A and 9B) for notifying the user of the result of the error diagnosis on the diagnosis target job. The controller unit 101 then displays the diagnosis result screen 900 such that the user can check it.

FIGS. 9A and 9B are diagrams illustrating an example of the diagnosis result screen 900 displayed in S605. The diagnosis result screen 900 includes a candidate error cause list 901 and an action details display region 904.

The candidate error cause list 901 lists the candidate(s) of the cause(s) of the error determined by the error diagnosis in S604 for the diagnosis target job. The candidate error cause list 901 in FIG. 9A displays two candidates of the cause of the error, namely “TLS Version Mismatch” and “Missing Common Encryption Algorithm(s).” The action details display region 904 includes a region 905 that displays instructions as actions to be taken to handle a candidate selected from the candidate error cause list 901, and a region 906 that displays related setting values of the image forming apparatus 100. Also, the action details display region 904 includes a region 907 that displays the exit code of the diagnosis target job. In a case where a close button 908 is pressed, the controller unit 101 closes the diagnosis result screen 900 and displays the home screen 500.

FIG. 9A is the diagnosis result screen 900 in a case where “TLS Version Mismatch” held in a row 902 is selected from among the candidates included in the candidate error cause list 901. The region 905 in the action details display region 904 displays a detailed description of “TLS Version Mismatch,” which is the selected candidate of the cause of the error, and an error solution which the user can implement to eliminate the cause of the error “TLS Version Mismatch.” The region 906 displays setting values of the image forming apparatus 100 related to “TLS Version Mismatch.”

FIG. 9B is the diagnosis result screen 900 in a case where “Missing Common Encryption Algorithm(s)” held in a row 903 is selected from among the candidates included in the candidate error cause list 901. In a case where the selected candidate in the candidate error cause list 901 is changed, the screen is controlled to display text corresponding to the changed candidate in the action details display region 904. The display of the region 905 in the action details display region 904 in FIG. 9B has been changed to an error solution corresponding to “Missing Common Encryption Algorithm(s).” Also, the display of the region 906 in the action details display region 904 in FIG. 9B has been changed to setting values of the image forming apparatus 100 related to “Missing Common Encryption Algorithm(s).” A two-dimensional code or the like, for example, may be displayed in the action details display region 904 as a link to a corresponding manual instead of or in addition to the error solutions displayed in FIGS. 9A and 9B. By checking the details displayed in the action details display regions 904 in FIGS. 9A and 9B and taking actions such as making setting changes, the user can eliminate the cause of the error by themselves without having to request a repair service by a service engineer.

The diagnosis result screen 900 in FIGS. 9A and 9B is an example of a screen that presents multiple candidates of the cause of the error due to the result of the error by the error diagnosis indicating at least one of “TLS Version Mismatch” or “Missing Common Encryption Algorithm(s)” as a possible cause of the error. However, the actual cause of the error also tends to be either one of “TLS Version Mismatch” or “Missing Common Encryption Algorithm(s).” As described earlier, the error diagnosis executed in S604 is done by obtaining the candidates that have been associated with the exit code in advance. The exit code is associated with an error notification, which is based on information automatically sent from the outside. For this reason, the error diagnosis is sometimes unable to narrow down candidates of the cause of the error to a single candidate. As a result, multiple candidates of the cause of the error may be displayed, as illustrated in FIGS. 9A and 9B.

In this case, the user must select the candidates included in the candidate error cause list 901 one by one and implement the error solution displayed in the action details display region 904 to check whether the error is solved. Thus, it will be troublesome for the user in a case where many candidates of the cause of the error are displayed in the candidate error cause list 901. It is therefore preferable to reduce the number of candidates of the cause of the error displayed in the candidate error cause list 901. In view of this, in the present embodiment, an additional diagnosis is performed to reduce the number of candidates of the cause of the error to be displayed in the candidate error cause list 901.

### Job Diagnosis in Present Embodiment

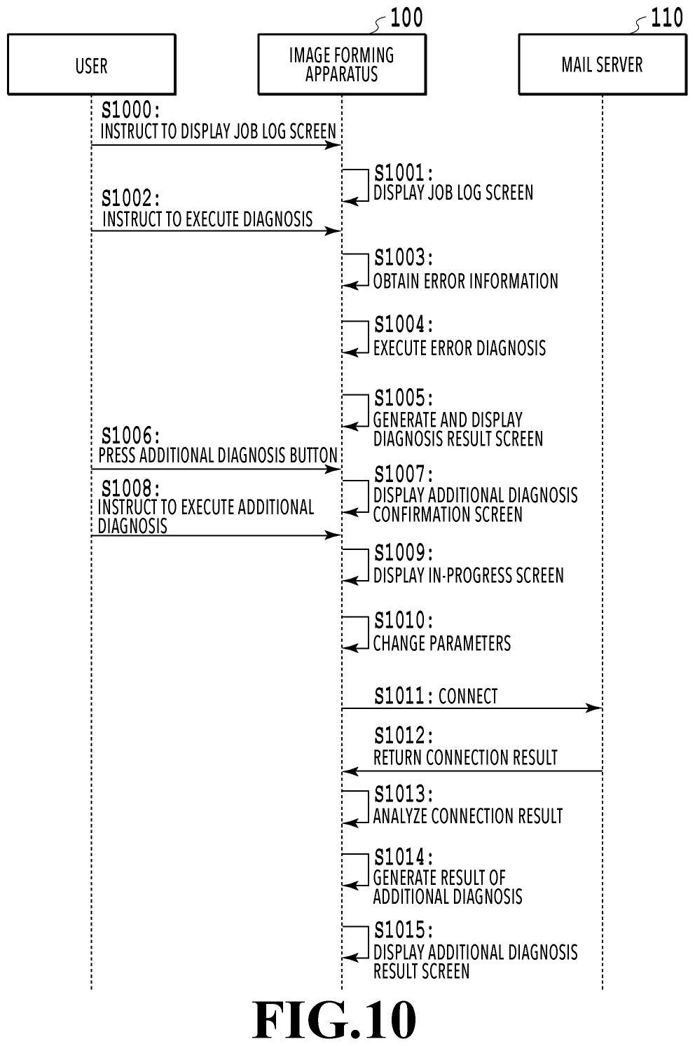

FIG. 10 is a sequence chart for generally describing a series of processes for the controller unit 101 of the image forming apparatus 100 to perform an error diagnosis on a diagnosis target job selected by the user and further perform an additional diagnosis.

S1000 to S1004 preceding a process of displaying the result of the error diagnosis are the same as S600 to S604 in FIG. 6, and description thereof is therefore omitted.

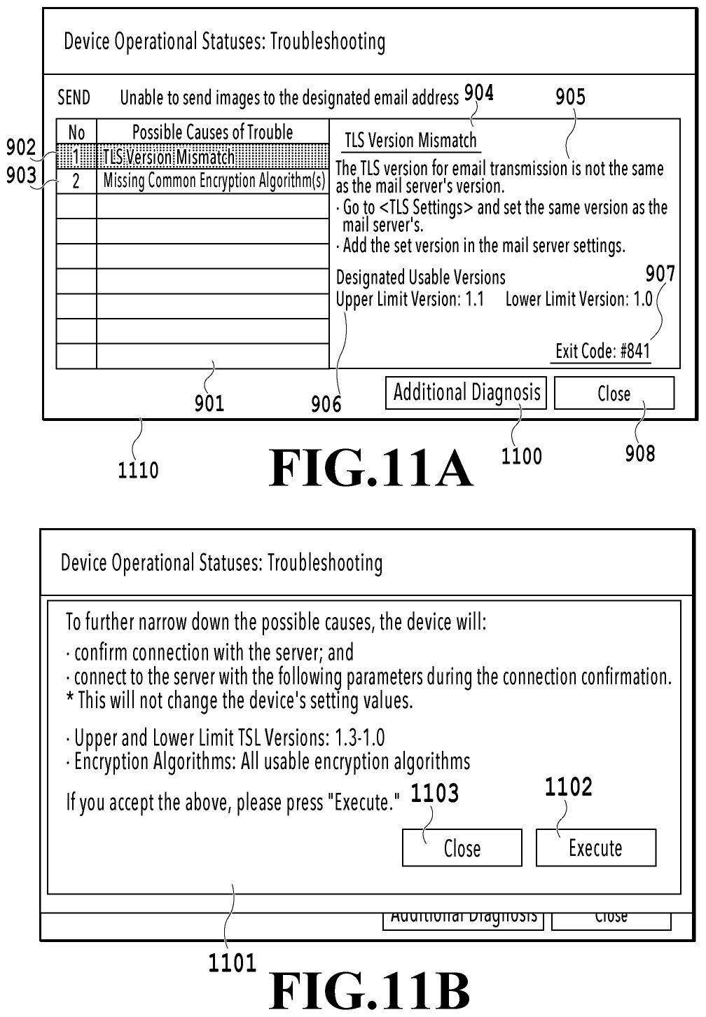

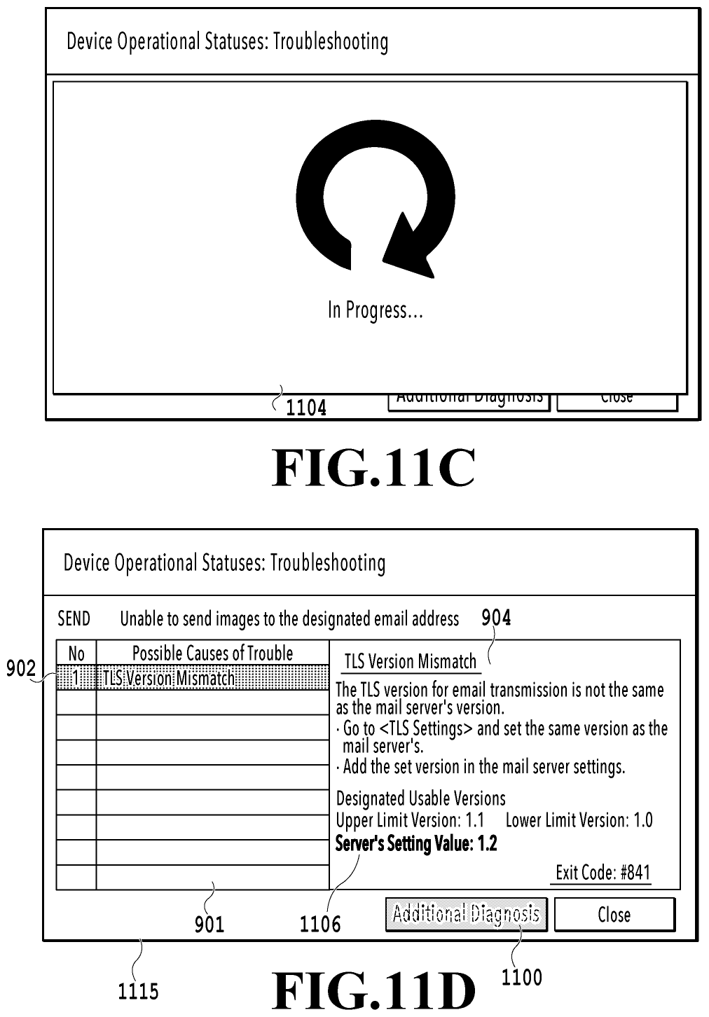

In S1005, the controller unit 101 displays a diagnosis result screen 1110 (see FIG. 11A) as a screen for notifying of the result of the error diagnosis performed on the diagnosis target job selected by the user in S1002.

FIG. 11A is a diagram illustrating an example of the diagnosis result screen 1110 in the present embodiment displayed in S1005. The same portions as those of the diagnosis result screen 900 in FIGS. 9A and 9B are denoted by the same reference signs. In S1005, in a case of displaying multiple candidates in the candidate error cause list 901, the controller unit 101 displays the diagnosis result screen 1110, in which an additional diagnosis button 1100 is added, as illustrated in FIG. 11A. The controller unit 101 may display the diagnosis result screen 900 in FIGS. 9A and 9B in a case where the candidate error cause list 901 includes only one candidate of the cause of the error.

The following steps represent a processing flow in a case where the diagnosis result screen 1110 in FIG. 11A is displayed in S1005 and the additional diagnosis button 1100 is then pressed.

In S1006, the user presses the additional diagnosis button 1100 included in the diagnosis result screen 1110.

In S1007, in response to accepting the pressing of the additional diagnosis button 1100, the controller unit 101 displays an additional diagnosis confirmation screen 1101 (see FIG. 11B).

FIG. 11B is a diagram illustrating an example of the additional diagnosis confirmation screen 1101. The additional diagnosis confirmation screen 1101 is a screen that displays details of processes to be executed in the additional diagnosis and confirms with the user whether to execute the additional diagnosis. In a case where the user presses a close button 1103, the controller unit 101 of the image forming apparatus 100 closes the additional diagnosis confirmation screen 1101 and displays the diagnosis result screen 1110.

In S1008, the user presses an additional diagnosis execution button 1102 included in the additional diagnosis confirmation screen 1101, and the controller unit 101 accepts the instruction to execute the additional diagnosis.

In S1009, the controller unit 101 displays an in-progress screen 1104 as illustrated in FIG. 11C in response to accepting the instruction to execute the additional diagnosis from the user.

In S1010, the controller unit 101 obtains the exit code associated with the diagnosis target job. Then, the controller unit 101 changes the value of the parameter corresponding to the obtained exit code among parameters for connecting to the mail server 110. S1010 involves temporarily changing the value of the parameter for the additional diagnosis, not changing the value of the parameter that is used during job execution.

In S1011, the controller unit 101 attempts to connect to the mail server 110 by using the changed parameter. In S1012, the mail server 110 returns a response to the connection attempt to the controller unit 101. In S1013, the controller unit 101 analyzes the connection result based on the response from the mail server 110. Details of S1011 to S1013 will be described later.

In S1014, based on the result of the analysis in S1013, the controller unit 101 generates an additional diagnosis result screen 1115 (FIG. 11D) which is a screen for notifying the user of the result of the additional diagnosis.

In S1015, the controller unit 101 displays the additional diagnosis result screen 1115.

FIG. 11D is a diagram illustrating an example of the additional diagnosis result screen 1115. The basic layout of the additional diagnosis result screen 1115 is similar to that of the diagnosis result screen 1110 in FIG. 11A displayed in S1005. However, the additional diagnosis result screen 1115 in FIG. 11D differs from the diagnosis result screen 1110 in FIG. 11A in that the candidates displayed in the candidate error cause list 901 have been changed to the only one candidates of the error cause held in the row 902. Also, the action details display region 904 in the additional diagnosis result screen 1115 in FIG. 11D additionally includes a region 1106 that displays a setting value of the mail server 110 which was found by the additional diagnosis. Also, the screen is controlled such that the additional diagnosis button 1100 included in the additional diagnosis result screen 1115 in FIG. 11D is grayed out so that pressing of the button will not be accepted.

As described above, in the additional diagnosis executed in the present embodiment, the controller unit 101 of the image forming apparatus 100 temporarily changes the value of a parameter for connecting to the mail server 110 and confirms the connection with the mail server 110 with the changed value of the parameter. In this way, the additional diagnosis can reduce the number of candidates of the cause of the error. The parameter change in the additional diagnosis is only made temporarily in order to confirm the connection with the mail server 110, and does not change the setting value to be used by the image forming apparatus 100 to actually execute jobs.

Additional Diagnosis with Exit Code “#752”

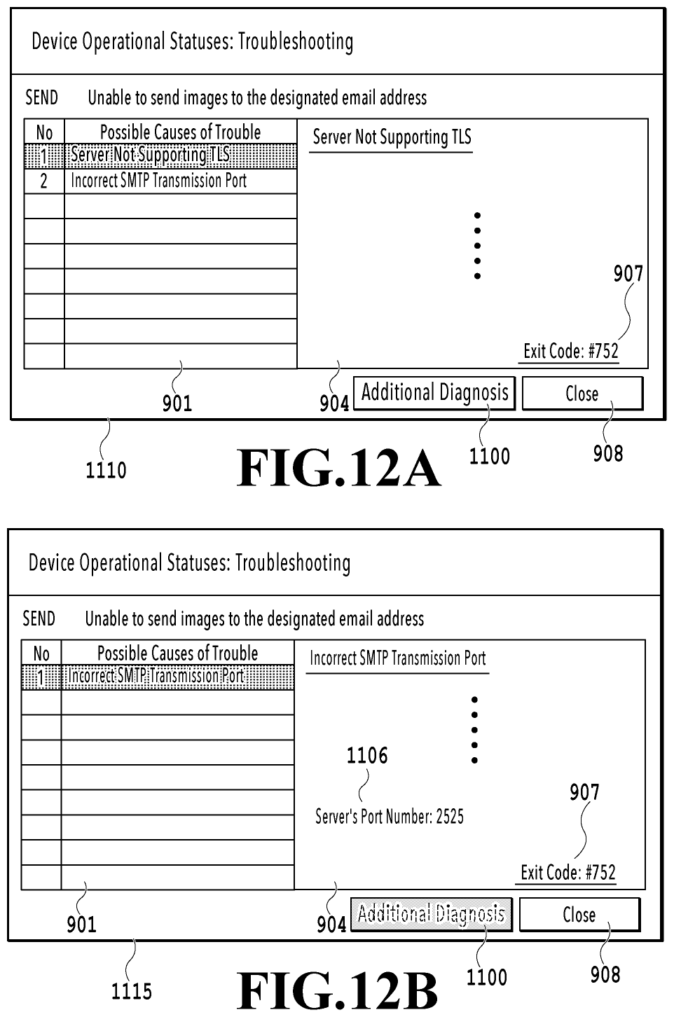

FIG. 12A is a diagram illustrating an example of the diagnosis result screen 1110 displayed after an error diagnosis but before an additional diagnosis in a case where the exit code associated with a diagnosis target job is “#752.” In FIGS. 12A and 12B, the action details display region 904 is illustrated with no description in the region 905, which displays instructions as actions to be taken, or the region 906, which displays setting values of the image forming apparatus 100.

Details of the additional diagnosis executed in S1010 to S1013 in a case where the exit code for the diagnosis target job is “#752” will now be described. The exit code “#752” is an exit code associated with a job in which an error occurred due to a mail transmission failure caused by at least one of “Server Not Supporting TLS” or “Incorrect SMTP Transmission Port.” Thus, in a case where a job with which the exit code “#752” is associated is the diagnosis target and subjected to the error diagnosis in S1004, “Server Not Supporting TLS” and “Incorrect SMTP Transmission Port” are displayed in the candidate error cause list 901, as illustrated in FIG. 12A. In this case, the additional diagnosis will involve a process of identifying which candidate was the cause of the error that occurred in the diagnosis target job between “Server Not Supporting TLS” and “Incorrect SMTP Transmission Port.”

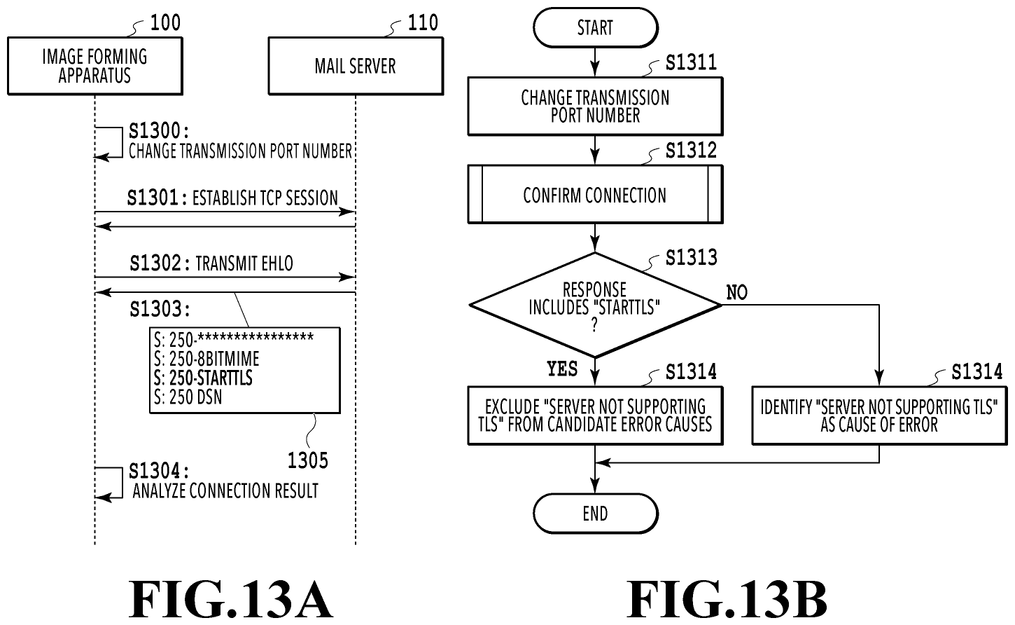

FIGS. 13A and 13B are diagrams for describing a process of confirming whether “Server Not Supporting TLS,” which is one of the candidates for the exit code “#752,” is the actual cause of the error.

There is a case where the image forming apparatus 100 communicates with the mail server 110 by using Transport Layer Security (TLS). Note that “Server Not Supporting TLS” means a case where the image forming apparatus 100 attempted to communicate with the mail server 110 by using TLS but an error occurred due to the mail server 110 being a server not supporting TLS.

FIG. 13A is a sequence chart for describing a flow of processing by the controller unit 101 of the image forming apparatus 100 and the mail server 110 in a case of confirming whether “Server Not Supporting TLS” is the actual cause of an error.

S1300 is a step corresponding to S1010. In S1300, in response to receiving an instruction to execute an additional diagnosis on the result of an error diagnosis in which the exit code is “#752,” the controller unit 101 of the image forming apparatus 100 changes the SMTP transmission port number for communicating with the mail server 110.

S1301 to S1303 are steps corresponding to S1011 and S1012. In S1301, the controller unit 101 establishes a TCP session with the mail server 110. In S1302, the controller unit 101 transmits an extended hello (EHLO) to the mail server 110.

In S1303, the mail server 110 returns the communication method supported by the mail server 110 as a response to the contents of the EHLO transmitted from the controller unit 101 of the image forming apparatus 100. Response information 1305 in FIG. 13A indicates part of an example of the contents returned by the mail server 110 in S1303.

S1304 is a step corresponding to S1013, in which the controller unit 101 analyzes the connection result based on the response from the mail server 110. In this step, the controller unit 101 of the image forming apparatus 100 analyzes the response information 1305 to identify whether the error that occurred in the diagnosis target job was caused by “Server Not Supporting TLS.”

FIG. 13B is a flowchart for describing details of the processing by the image forming apparatus 100 in FIG. 13A.

S1311 is a step corresponding to S1300 in FIG. 13A. In S1311, the controller unit 101 of the image forming apparatus 100 changes the port number to a port number with which the image forming apparatus 100 performs communication using STARTTLS. For example, in a case where a transmission port number “465” is set as a transmission port number for performing SMTP over SSL/TLS (SMTPS) communication, the controller unit 101 changes the port number to a transmission port number other than “465.” Also, it is assumed that the port number setting of the mail server 110 is changed to match the changed port number. The reason for changing to a port number other than the port number “465,” which is for performing SMTPS communication, is that an EHLO will be transmitted in the next step S1312 and non-SMTPS communication will therefore be preferable.

In S1312, the image forming apparatus 100 performs the connection confirmation illustrated in S1301 to S1303 in FIG. 13A.

S1313 to S1315 are steps illustrating details of S1304 in FIG. 13A. In S1313, the controller unit 101 having performed the connection confirmation illustrated in S1301 to S1303 determines whether the response information 1305 from the mail server 110 includes “STARTTLS.”

The controller unit 101 advances the processing to S1314 if determining that the response information 1305 includes “STARTTLS” (YES in S1313). In the case where the response information from the mail server 110 includes “STARTTLS,” it means that the mail server 110 supports TLS communication. It can therefore be considered that the cause of the error that occurred in the diagnosis target job is at least not “Server Not Supporting TLS.” Then, in S1314, the controller unit 101 can identify that “Server Not Supporting TLS” presented to the user as one candidate is not the cause of the error that occurred in the diagnosis target job. Accordingly, “Server Not Supporting TLS” can be removed from the candidates in FIG. 12A.

If, on the other hand, determining that the response information 1305 does not include “STARTTLS” (NO in S1313), the controller unit 101 advances the processing to S1315. In the case where the response information from the mail server 110 does not include “STARTTLS,” it means that the mail server 110 does not support TLS communication. Then, in S1315, the controller unit 101 can identify that at least “Server Not Supporting TLS” is one cause of the error.

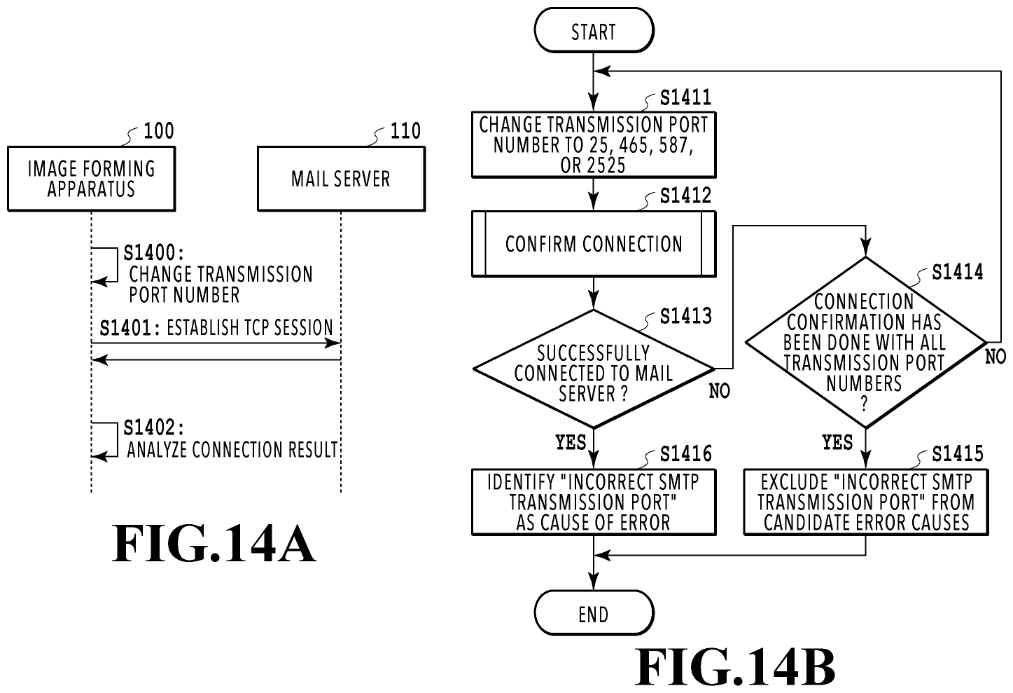

FIGS. 14A and 14B are diagrams for describing processing for confirming whether “Incorrect SMTP Transmission Port,” which is one of the candidates of the cause of the error for the exit code “#752,” is the actual cause of the error. Note that “Incorrect SMTP Transmission Port” refers to a case where the port number set in the image forming apparatus 100 for communicating with the mail server 110 and the port number set in the mail server 110 are different, resulting in an error.

FIG. 14A is a sequence chart for describing a flow of processing by the controller unit 101 of the image forming apparatus 100 and the mail server 110 in a case of confirming whether “Incorrect SMTP Transmission Port” is the actual cause of the error.

S1400 is a step corresponding to S1010. S1400 is executed in response to completion of narrowing of candidate actions for handling “Server Not Supporting TLS.” In S1400, the controller unit 101 of the image forming apparatus 100 changes the SMTP transmission port number for communicating with the mail server 110. Details will be described later.

S1401 is a step corresponding to S1011 and S1012. In S1401, the controller unit 101 establishes a TCP session with the mail server 110 with the set port number.

S1402 is a step corresponding to S1013, in which the controller unit 101 analyzes the connection result based on the response from the mail server 110.

FIG. 14B is a flowchart for describing details of the processing by the controller unit 101 of the image forming apparatus 100 in the sequence chart of FIG. 14A.

S1411 is a step corresponding to S1400 in FIG. 14A. In S1411, the controller unit 101 of the image forming apparatus 100 changes the transmission port number. The controller unit 101 changes the transmission port number to a transmission port number that has not yet been set among representative SMTP transmission port numbers. For example, the controller unit 101 changes the transmission port number to a transmission port number that has not yet been set among “25,” “465,” “587,” and “2525.” The controller unit 101 does not change the transmission port number to the transmission port number that is set in the image forming apparatus 100 at the start of the flowchart.

In S1412, the controller unit 101 performs the connection confirmation illustrated in S1401 in FIG. 14A and proceeds to S1413.

S1413 to S1416 are steps illustrating details of S1402 in FIG. 14A.

In S1413, the controller unit 101 determines whether a connection was successfully established with the mail server 110 based on the result of S1412. For example, the controller unit 101 determines that a connection was successfully established with the mail server 110 in a case where a TCP 3-way handshake succeeded.

The controller unit 101 advances the processing to S1414 if determining that a connection could not be established with the mail server 110 (NO in S1413).

In S1414, the controller unit 101 determines whether connection confirmation has been done with all SMTP transmission port numbers. All SMTP transmission port numbers mean “25,” “465,” “587,” and “2525,” for example. If determining that connection confirmation has not been done with all transmission port numbers (NO in S1414), the controller unit 101 returns to S1411, and changes the transmission port number to one that has not yet been set.

If determining that connection confirmation has been done with all transmission port numbers (YES in S1414), the controller unit 101 advances the processing to S1415.

Moving to S1415 means that a connection could not be established with the mail server 110 even by changing the transmission port number. It can therefore be considered that the cause of the error that occurred in the diagnosis target job is at least not “Incorrect SMTP Transmission Port.” Then, in S1415, the controller unit 101 can identify that “Incorrect SMTP Transmission Port” presented to the user as one candidate is not the cause of the error that occurred in the diagnosis target job. Accordingly, “Incorrect SMTP Transmission Port” can be removed from the candidates of the cause of the error illustrated in FIG. 12A.

If, on the other hand, determining that a connection was successfully established with the mail server 110 with the changed transmission port number (YES in S1413), the controller unit 101 advances the processing to S1416.

In S1416, the controller unit 101 identifies that at least “Incorrect SMTP Transmission Port” is one cause of the error that occurred in the diagnosis target job, since a connection was successfully established with the mail server 110 by changing the transmission port number. Also, the controller unit 101 holds the set transmission port number with which a connection was successfully established with the mail server 110 so that it can be displayed in the region 1106 in the action details display region 904, which displays setting values of the mail server 110.

FIG. 12B is a diagram illustrating the additional diagnosis result screen 1115 displayed as a result of pressing the additional diagnosis button 1100 in FIG. 12A and performing an additional diagnosis. Assume that the candidates of the cause of the error for the exit code “#752” were narrowed down such that “Incorrect SMTP Transmission Port” was identified as a cause of the error and “Server Not Supporting TLS” was not identified as a cause of the error. In this case, the controller unit 101 displays only “Incorrect SMTP Transmission Port” as the identified candidate of the cause of the error in the candidate error cause list 901 in the additional diagnosis result screen 1115.

Note that the process of identifying whether “Incorrect SMTP Transmission Port” is a cause in FIGS. 14A and 14B may be followed by the process of identifying whether “Server Not Supporting TLS” is a cause in FIGS. 13A and 13B.

Additional Diagnosis with Exit Code “#841”

Next, details of the additional diagnosis executed in S1010 to S1013 in a case where the exit code for the diagnosis target job is “#841” will be now described.

In the case where the exit code is “#841,” it means that the port number was appropriate, and therefore a TCP session was successfully established and a connection was successfully established with the mail server 110, but the job failed due to at least one of “TLS Version Mismatch” or “Missing Common Encryption Algorithm(s).” Thus, in a case where a job with an exit code associated with “#841” is subjected to the error diagnosis in S1004, “TLS Version Mismatch” and “Missing Common Encryption Algorithm(s)” as two candidates are displayed in the candidate error cause list 901. The additional diagnosis in this case involves a process of identifying which candidate was the cause of the error that occurred in the diagnosis target job between “TLS Version Mismatch” and “Missing Common Encryption Algorithm(s).”

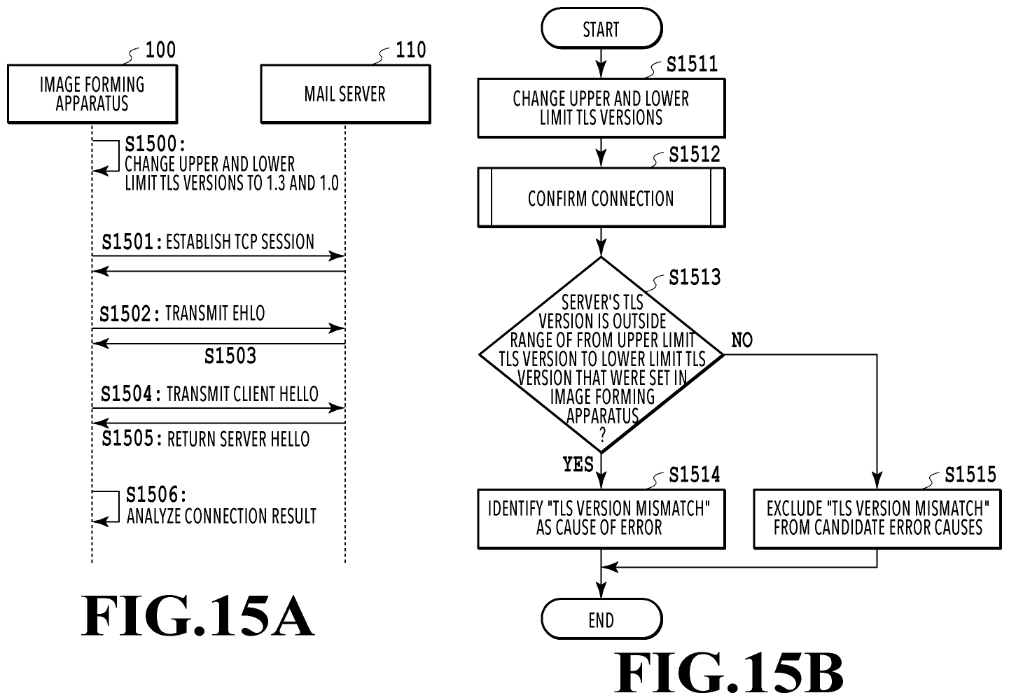

FIGS. 15A and 15B are diagrams for describing a process of confirming whether “TLS Version Mismatch,” which is one of the candidates for the exit code “#841,” is the actual cause of the error.

Note that “TLS Version Mismatch” refers to a case where the image forming apparatus 100 attempted to communicate with the mail server 110 by using TLS but an error occurred due to the image forming apparatus 100 designating a TLS version not supported by the mail server 110 for the communication.

FIG. 15A is a sequence chart for describing a flow of processing by the controller unit 101 of the image forming apparatus 100 and the mail server 110 in a case of identifying whether “TLS Version Mismatch” is the actual cause of an error.

S1500 is a step corresponding to S1010, and is executed in response to reception of an instruction to execute an additional diagnosis on the result of the diagnosis in which the exit code is “#841.” In S1500, the controller unit 101 of the image forming apparatus 100 changes the setting on the upper and lower limit TLS versions usable by the image forming apparatus 100 for communication with the mail server 110.

S1501 to S1505 are steps corresponding to S1011 and S1012. In S1501, the controller unit 101 establishes a TCP session with the mail server 110. In S1502, the controller unit 101 transmits an EHLO to the mail server. In S1503, the mail server 110 responds to the EHLO transmitted from the controller unit 101 of the image forming apparatus 100.

In S1504, the controller unit 101 transmits a client hello to the mail server 110 according to the contents of the response to the EHLO transmitted from the mail server 110. In doing so, the controller unit 101 includes the upper and lower limit TLS versions usable by the image forming apparatus 100 that were set in S1500 in the client hello.

In S1505, the mail server 110 returns a server hello as a response to the client hello transmitted from the image forming apparatus 100. The server hello includes response information including information on the TLS version which the mail server 110 will use in the TLS communication. For example, the mail server 110 responds by returning a usable TLS version out of the list of usable TLS versions transmitted by the image forming apparatus 100 in S1504. The mail server 110 returns an error response, for example, in a case where none of versions in the list of TLS versions transmitted from the image forming apparatus 100 is usable.

S1506 is a step corresponding to S1013, in which the controller unit 101 analyzes the connection result based on the response from the mail server 110, and narrows down the candidates of the cause of the error.

FIG. 15B is a flowchart for describing details of the processing by the image forming apparatus 100 in FIG. 15A.

S1511 is a step corresponding to S1500 in FIG. 15A. In S1511, the controller unit 101 of the image forming apparatus 100 changes the upper and lower limit TLS versions as described in S1500. The controller unit 101 changes the highest settable value for the image forming apparatus 100 to the upper limit TLS version, and changes the lowest settable value for the image forming apparatus 100 to the lower limit TLS version. For example, the upper limit is changed to 1.3, and the lower limit is changed to 1.0.

In S1512, the image forming apparatus 100 performs the connection confirmation illustrated in S1501 to S1505 in FIG. 15A.

S1513 to S1515 are steps illustrating details of S1506 in FIG. 15A. In S1513, the controller unit 101 having performed the connection confirmation illustrated in S1501 to S1505 obtains the TLS version included in the response information in the server hello as a TLS version supported by the mail server 110. The controller unit 101 determines whether the TLS version supported by the mail server 110 is a value outside the range of from the upper limit TLS version to the lower limit TLS version that were set in the image forming apparatus 100. The upper and lower limit TLS versions that were set in the image forming apparatus 100 are the upper and lower limits TLS versions used during the mail transmission that were set in the image forming apparatus 100 in S1011. For example, assume that the upper and lower limit TLS versions that were set in the image forming apparatus 100 during the mail transmission in S1011 were “1.1” and “1.0,” respectively, and the TLS version that is designated in the mail server 110 is “1.2.” In this case, the controller unit 101 can determine that the TLS version of the mail server 110 is outside the range.

If determining that the TLS version of the mail server 110 is outside the TLS version range that was set in the image forming apparatus 100 (YES in S1513), the controller unit 101 advances the processing to S1514.

In S1514, the controller unit 101 identifies that at least “TLS Version Mismatch” is one cause of the error that occurred in the diagnosis target job. The controller unit 101 holds the value indicating the TLS version included in the response information from the mail server 110 so that it can be displayed in the region 1106 in the action details display region 904.

If determining that the TLS version of the mail server 110 is inside the TLS version range that was set in the image forming apparatus 100 (NO in S1513), the controller unit 101 advances the processing to S1515.

Moving to S1515 means that the TLS version that was set in the image forming apparatus 100 was an appropriate version. It can therefore be considered that the cause of the error that occurred in the diagnosis target job is at least not “TLS Version Mismatch.” Then, in S1515, the controller unit 101 can identify that “TLS Version Mismatch” presented to the user as one candidate is not the cause of the error that occurred in the diagnosis target job. Accordingly, the controller unit 101 can remove “TLS Version Mismatch” displayed as a candidate in the candidate error cause list 901 in FIG. 11A.

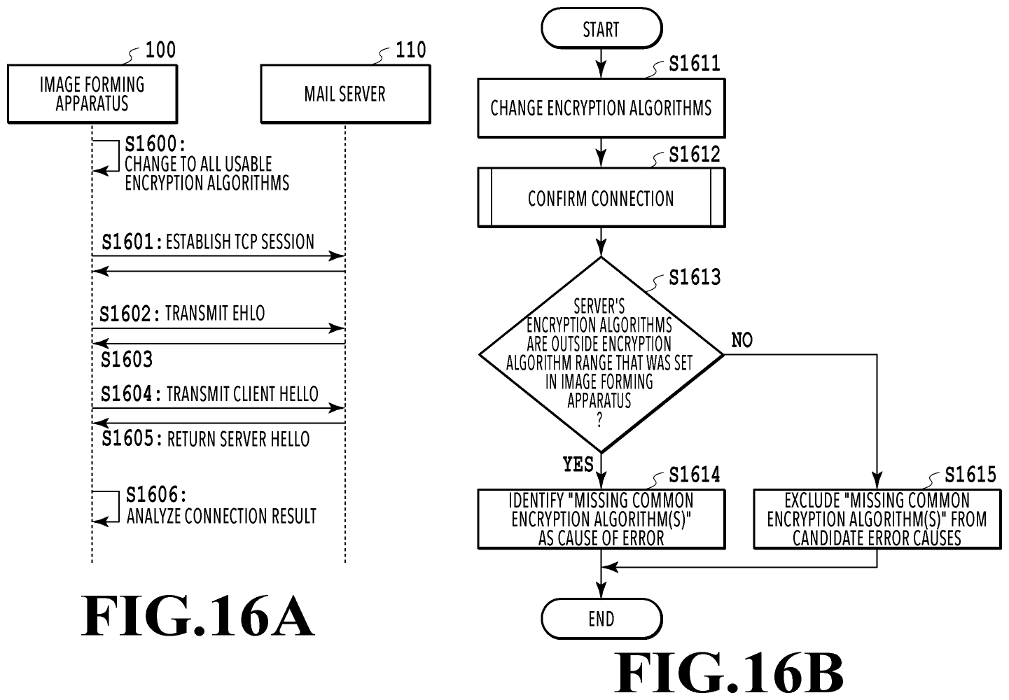

FIGS. 16A and 16B are diagrams for describing a process of confirming whether “Missing Common Encryption Algorithm(s),” which is one of the candidates of the cause of the error for the exit code “#841,” is the actual cause of the error.

Note that “Missing Common Encryption Algorithm(s)” refers to a case where the image forming apparatus 100 attempted to communicate with the mail server 110 by using TLS but an error occurred due to the image forming apparatus 100 designating an encryption algorithm(s) not supported by the mail server 110 for the communication.

FIG. 16A is a sequence chart for describing a flow of processing by the controller unit 101 of the image forming apparatus 100 and the mail server 110 in a case of identifying whether “Missing Common Encryption Algorithm(s)” is the actual cause of an error.

S1600 is a step corresponding to S1010. S1600 is executed after receiving an instruction to execute an additional diagnosis on a diagnosis result with the exit code “#841” and completing identifying whether “TLS Version Mismatch” is the cause of the error. In S1600, the controller unit 101 of the image forming apparatus 100 changes the encryption algorithms to be used in the TLS communication with the mail server 110.

S1601 to S1605 are steps corresponding to S1011 and S1012. In S1601, the controller unit 101 establishes a TCP session with the mail server 110. In S1602, the controller unit 101 transmits an EHLO to the mail server 110. In S1603, the mail server 110 responds to the EHLO transmitted from the controller unit 101 of the image forming apparatus 100.

In S1604, the controller unit 101 transmits a client hello to the mail server 110 according to the contents of the response to the EHLO transmitted from the mail server 110. The controller unit 101 includes all encryption algorithms usable by the image forming apparatus 100 that were set in S1600 in the client hello.

In S1605, the mail server 110 returns a server hello as a response to the client hello transmitted from the image forming apparatus 100. The server hello includes response information including information on the encryption algorithms which the mail server will use in the TLS communication. For example, the mail server 110 responds by returning encryption algorithms out of the list of usable encryption algorithms transmitted by the image forming apparatus 100 in S1604. The mail server 110 returns an error response, for example, in a case where none of algorithms in the list of encryption algorithms transmitted from the image forming apparatus 100 is usable.

S1606 is a step corresponding to S1013, in which the controller unit 101 analyzes the connection result based on the response from the mail server 110 and narrows down the candidates of the cause of the error.

FIG. 16B is a flowchart for describing details of the processing by the image forming apparatus 100 in FIG. 16A.

S1611 is a step corresponding to S1600 in FIG. 16A. In S1611, the controller unit 101 of the image forming apparatus 100 changes the encryption algorithms to be used in the TLS communication, as described in S1600. The controller unit 101 changes the encryption algorithms to all encryption algorithms that are settable in the image forming apparatus 100. For example, assume that the settable encryption algorithms for the image forming apparatus 100 are as follows: AES-CBC, AES-GCM, 3DES-CBC, CHACHA20-POLY1305, RSA, ECDHE, X25519, ECDSA, SHA-1, SHA-256, and SHA-384. In this case, the controller unit 101 sets all of these encryption algorithms.

In S1612, the image forming apparatus 100 performs the connection confirmation illustrated in S1601 to S1605 in FIG. 16A.

S1613 to S1615 are steps illustrating details of S1606 in FIG. 16A. In S1613, the controller unit 101 having performed the connection confirmation illustrated in S1601 to S1605 obtains the encryption algorithms included in the response information in the server hello as encryption algorithms supported by the mail server 110. The controller unit 101 determines whether the encryption algorithms supported by the mail server 110 are values outside the encryption algorithm range that was set in the image forming apparatus 100. The encryption algorithms that were set in the image forming apparatus 100 are the encryption algorithms that were used during the mail transmission in S1011. For example, assume that the encryption algorithms which were set in the image forming apparatus 100 during the mail transmission in S1011 were “AES-CBC,” “3DES-CBC,” “RSA,” “ECDHE,” and “SHA1.” Assume also that “AES-GCM,” “X25519,” “RSA,” and “SHA384” were obtained as encryption algorithms which are designated in the mail server 110 as a result of the connection confirmation. In this case, the controller unit 101 can determine that the encryption algorithms supported by the mail server 110 are outside the range.

The controller unit 101 advances the processing to S1614 if determining that the encryption algorithms supported by the mail server 110 are outside the encryption algorithm range that was set in the image forming apparatus 100 (YES in S1613).

In S1614, the controller unit 101 identifies that at least “Missing Common Encryption Algorithm(s)” is one cause of the error that occurred in the diagnosis target job. The controller unit 101 holds the encryption algorithms designated by the mail server 110 so that they can be displayed in the region 1106 in the action details display region 904.

The controller unit 101 advances the processing to S1615 if determining that the encryption algorithms supported by the mail server 110 are inside the encryption algorithm range that was set in the image forming apparatus 100 (NO in S1613).

Moving to S1615 means that the encryption algorithms that were set in the image forming apparatus 100 were appropriate. It can therefore be considered that the cause of the error that occurred in the diagnosis target job is at least not “Missing Common Encryption Algorithm(s).” Then, in S1615, the controller unit 101 can identify that “Missing Common Encryption Algorithm(s)” presented to the user as one candidate is not the cause of the error that occurred in the diagnosis target job. Accordingly, the controller unit 101 can remove “Missing Common Encryption Algorithm(s)” displayed as a candidate in the candidate error cause list 901 in FIG. 11A.

FIG. 11D is a diagram illustrating the additional diagnosis result screen 1115 displayed as a result of pressing the additional diagnosis button 1100 in FIG. 11A and performing an additional diagnosis. Assume that the candidates of the cause of the error for the exit code “#841” were narrowed down such that “TLS version mismatch” was identified as a cause of the error and “Missing Common Encryption Algorithm(s)” was not identified as a cause of the error. In this case, the controller unit 101 displays only “TLS Version Mismatch” as the identified candidate of the cause of the error in the candidate error cause list 901 in the additional diagnosis result screen 1115. As described above, performing an additional diagnosis can reduce the number of candidates of the cause of the error displayed in the candidate error cause list 901.

Also, in the region 1106 in the action details display region 904, the controller unit 101 displays a setting value of the mail server 110 that was found as a result of connecting to the mail server in the additional diagnosis. Referring to the details of the action to be taken to handle the candidate identified by the additional diagnosis that is displayed in the action details display region 904, the user can take an actual action, such as making a setting change. For example, in FIG. 11D, a TLS version “1.2” is displayed in the region 1106 in the action details display region 904 as the setting value of the mail server 110 related to “TLS Version Mismatch” identified by the additional diagnosis. In this way, the user can solve the problem by themselves by changing the upper limit TLS version of the image forming apparatus 100 to “1.2” from “1.1.”

Note that the process of identifying whether “Missing Common Encryption Algorithm(s)” is a cause in FIGS. 16A and 16B may be followed by the process of identifying whether “TLS Version Mismatch” is a cause in FIGS. 15A and 15B.

In the present embodiment, an error diagnosis that determines one or more candidates of a cause of an error by using information on a job in which a problem occurred, which is information in the image forming apparatus 100, can be performed without communicating with the mail server 110. Here, multiple candidates of a cause of an error may be determined by the error diagnosis. In this case, solutions are individually displayed for the multiple candidate causes thus determined, and the user must try all of the displayed solutions, which is troublesome.

In the present embodiment, an additional diagnosis can further be performed using information obtained by connecting to the mail server 110 with an internal parameter(s) of the image forming apparatus 100 changed. Thus, in the present embodiment, the additional diagnosis narrows down the candidates of a cause of an error. This reduces the time and effort required for the user to solve the problem by themselves.

### Embodiment 2

Embodiment 1 has described a method that reduces the number of candidates of a cause of an error through an additional diagnosis performed by causing the image forming apparatus 100 to connect to the mail server 110 with an internal parameter(s) of the image forming apparatus 100 changed. Embodiment 2 will describe a method by which, in a case where the image forming apparatus 100 performed an additional diagnosis but failed to reduce the number of candidates of a cause of an error due to some reason, the user is notified of that fact. The present embodiment will mainly describe its difference from Embodiment 1. Features that are not particularly specified are the same components and processes as those in Embodiment 1.

Assume that a job with the exit code “#841” as a diagnosis target is subjected to an error diagnosis in S1004, and the diagnosis result screen 1110 with multiple candidates of the cause of the error is displayed. Assume also that the user issues an instruction to execute an additional diagnosis on the diagnosis result screen 1110 but the controller unit 101 of the image forming apparatus 100 fails to narrow down the candidates of the cause of the error by the additional diagnosis. Failing to narrow down the candidates of the cause of the error means either failing to reduce the number of candidates of the cause of the error or failing to make the number of candidates of the cause of the error equal to one.

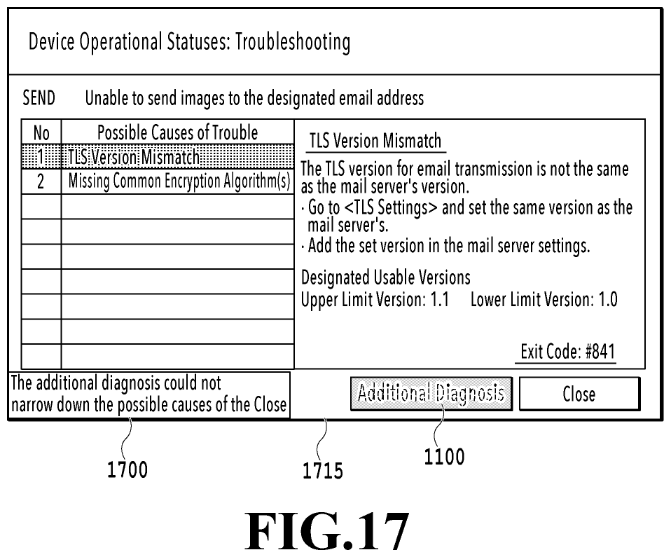

FIG. 17 is a diagram illustrating an additional diagnosis result screen 1715 in the present embodiment which is displayed in S1015 in a case where an additional diagnosis was executed but failed to narrow down the candidates of the cause of the error. The same portion as that of the additional diagnosis result screen 1115 in FIG. 11D is denoted by a reference sign with the same number.

The controller unit 101 of the image forming apparatus 100 displays an additional diagnosis failure message 1700 in the additional diagnosis result screen 1715 in order to indicate the user that an additional diagnosis was performed but failed to narrow down the candidates of the cause of the error. Also, since the additional diagnosis result screen 1715 is a screen after the additional diagnosis, the controller unit 101 grays the additional diagnosis button 1100 out so that it cannot be pressed. Note that the controller unit 101 of the image forming apparatus 100 may display details of an action to be taken that guides the user to a manual, such as a link, in the additional diagnosis result screen 1715.

As described above, according to the present embodiment, in a case where an additional diagnosis fails narrow down candidates of a cause of an error, the user can confirm that fact.

### Embodiment 3

Embodiment 1 has described a method which solves an error by displaying a setting value of the mail server 110 found by an additional diagnosis and having the user change a setting value of the image forming apparatus 100 to a value suitable for the setting value of the mail server 110. Here, although which setting value of the image forming apparatus 100 to change is known, the user still needs to open a setting change screen and perform operations on it, which is troublesome for the user. In view of this, the present embodiment will describe a method in which the controller unit 101 of the image forming apparatus 100 automatically changes a setting value of the image forming apparatus 100. The present embodiment will mainly describe its difference from Embodiment 1. Features that are not particularly specified are the same components and processes as those in Embodiment 1.

Assume that a job with the exit code “#841” as a diagnosis target is subjected to an error diagnosis in S1004, and the diagnosis result screen 1110 with multiple candidates of the cause of the error is displayed. Assume also that the user issues an instruction to execute an additional diagnosis on the diagnosis result screen 1110 and the controller unit 101 of the image forming apparatus 100 executes an additional diagnosis and successfully narrows down the candidates of the cause of the error to “TLS Version Mismatch.”

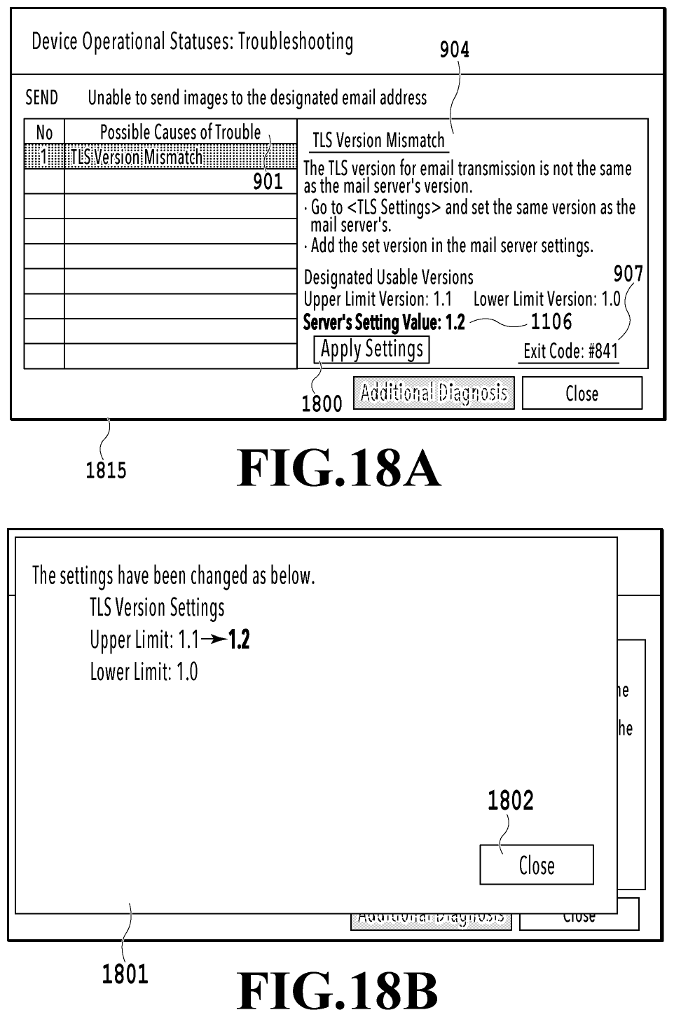

FIG. 18A is a diagram illustrating an additional diagnosis result screen 1815 in the present embodiment in a case where the candidates of the cause of the error have been narrowed down to “TLS Version Mismatch.” The same portions as those of the additional diagnosis result screen 1115 in FIG. 11D are denoted by reference signs with the same numbers.

Assume that a TLS version value “1.2” is obtained as the setting value of the mail server 110 related to the identified candidate of the cause of the error, “TLS Version Mismatch”, by the additional diagnosis. The controller unit 101 displays the additional diagnosis result screen 1815 in the present embodiment such that a setting application button 1800 is arranged in the screen. In a case where the user presses the setting application button 1800, the controller unit 101 of the image forming apparatus 100 automatically changes the setting value of the image forming apparatus 100 such that the image forming apparatus 100 can support the setting value of the mail server 110 obtained by the additional diagnosis.

In FIG. 18A, in the case where the setting application button 1800 is pressed, the controller unit 101 of the image forming apparatus 100 changes the upper limit TLS version of the image forming apparatus 100 to “1.2” from “1.1.” Changing the upper limit TLS version of the image forming apparatus 100 to “1.2” from “1.1” solves the error.

Also, the controller unit 101 of the image forming apparatus 100 displays a setting change screen 1801 illustrated in FIG. 18B to notify the user that the setting value of the image forming apparatus 100 has been changed. In a case where the user presses a close button 1802, the controller unit 101 closes the setting change screen 1801 and the additional diagnosis result screen 1815 and displays the home screen 500 on the touch panel.

As described above, according to the present embodiment, it is possible for the user to save the trouble of operating the image forming apparatus 100 to change its setting in order to eliminate the cause of an error identified by an additional diagnosis.

### Embodiment 4

In Embodiment 1, performing an additional diagnosis requires the user to press the additional diagnosis button 1100 in the diagnosis result screen 1110 displayed after execution of an error diagnosis and press the additional diagnosis execution button 1102 in the additional diagnosis confirmation screen 1101. Embodiment 4 will describe a method of automatically performing operations before an additional diagnosis in response to an instruction to execute an error diagnosis from the user. The present embodiment will mainly describe its difference from Embodiment 1. Features that are not particularly specified are the same components and processes as those in Embodiment 1.

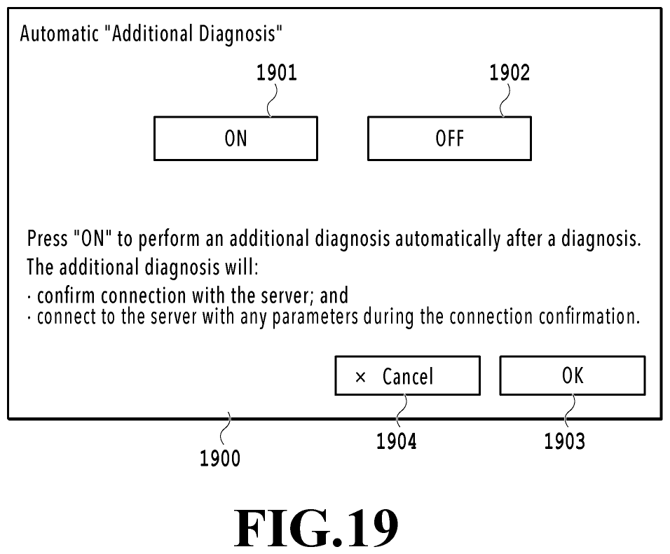

FIG. 19 is a diagram illustrating an additional diagnosis setting screen 1900. The additional diagnosis setting screen 1900 is displayed, for example, in response to pressing of a button for displaying the additional diagnosis setting screen 1900 in a screen not illustrated which is displayed in a case where a setting button 530 in the home screen 500 is pressed.

An ON button 1901 is a button for enabling a setting to automatically execute an additional diagnosis. An OFF button 1902 is a button for disabling the setting to automatically execute an additional diagnosis. The controller unit 101 controls the screen such that either one of the ON button 1901 or the OFF button 1902 can be pressed.

In a case where an OK button 1903 is pressed, the controller unit 101 enables or disables the setting to automatically execute an additional diagnosis according to the ON button 1901 or the OFF button 1902 that is pressed. The controller unit 101 then closes the additional diagnosis setting screen 1900 and returns to the home screen 500.

In the case where the setting to automatically execute an additional diagnosis is disabled, S1003 to S1015 in FIG. 10 are performed as described in Embodiment 1 in response to an instruction to execute an error diagnosis from the user in S1002. That is, in order to perform an additional diagnosis, in S1006, the user presses the additional diagnosis button 1100 in the diagnosis result screen 1110 which is displayed after execution of an error diagnosis. Further in S1008, the user needs to press the additional diagnosis execution button 1102 in the additional diagnosis confirmation screen 1101.

In the case where the setting to automatically execute an additional diagnosis is enabled, the controller unit 101 executes the processes of S1003 and S1004 and then the processes from S1009 in FIG. 10 in response to an instruction to execute an error diagnosis from the user in S1002. That is, the processes for an additional diagnosis are automatically performed without displaying the diagnosis result screen in S1005 and the additional diagnosis confirmation screen in S1007. Note that the process of S1005 is performed in a case where only one candidate of the cause of the error is determined in

S1004. Thus, the user simply issues an instruction to execute an error diagnosis in S1002, and the controller unit 101 executes an error diagnosis and an additional diagnosis.

As described above, according to the present embodiment, it is possible to save the user the trouble of performing operations before an additional diagnosis.

### Embodiment 5

In Embodiment 1, to issue an instruction to perform an error diagnosis on a job in which an error occurred, the user needs to display the job log screen 700 or the mail transmission troubleshooting screen 804, select the diagnosis target job, and issue an instruction to perform an error diagnosis on it. Embodiment 5 will describe a method in which the user issues an instruction to perform an error diagnosis on a job on an exit screen that is displayed after the job is executed. The present embodiment will mainly describe its difference from Embodiment 1. Features that are not particularly specified are the same components and processes as those in Embodiment 1.

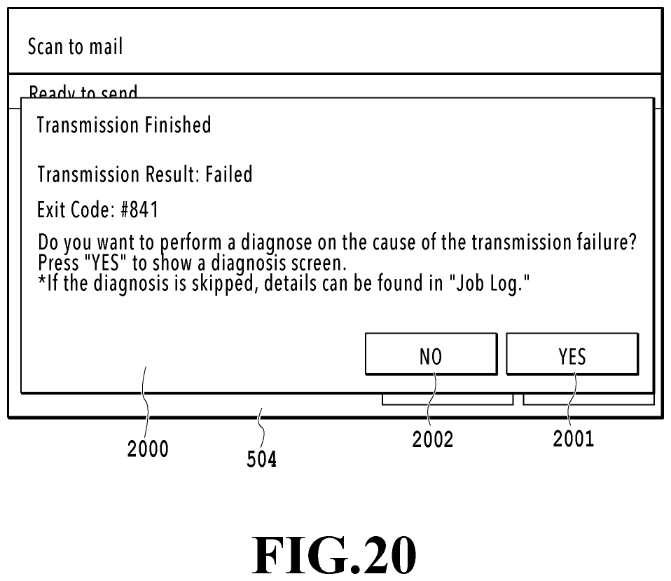

FIG. 20 is a diagram illustrating an exit screen in the present embodiment. An exit screen 2000 in FIG. 20 represents an exit screen that is displayed in the present embodiment in a case where “Failure” is given as a transmission result. Specifically, in a case where the user issues an instruction to transmit mail in S408 and the controller unit 101 attempts to transmit the mail in S410 but fails to do so, the controller unit 101 displays the exit screen 2000 in S413.

The controller unit 101 of the image forming apparatus 100 accepts pressing of a YES button 2001 in the exit screen 2000 in FIG. 20 as an instruction to execute an error diagnosis in S1002. That is, in a case where the YES button 2001 is pressed, the executed job is set as a diagnosis target job and subjected to an error diagnosis in S1003 and a subsequent step.

In a case where the user presses a NO button 2002 in the exit screen 2000, the controller unit 101 of the image forming apparatus 100 closes the exit screen 2000 and displays the scan-to-mail setting screen 504.

As described above, according to the present embodiment, it is possible to save the user the trouble of selecting a diagnosis target job.

### Embodiment 6

Embodiment 1 has been described on the assumption that the values of parameters to be changed in an additional diagnosis have been individually determined for each exit code in advance. Embodiment 6 will describe a method in which values selected by the user are used as the values of parameters to be changed in an additional diagnosis. The present embodiment will mainly describe its difference from Embodiment 1. Features that are not particularly specified are the same components and processes as those in Embodiment 1.

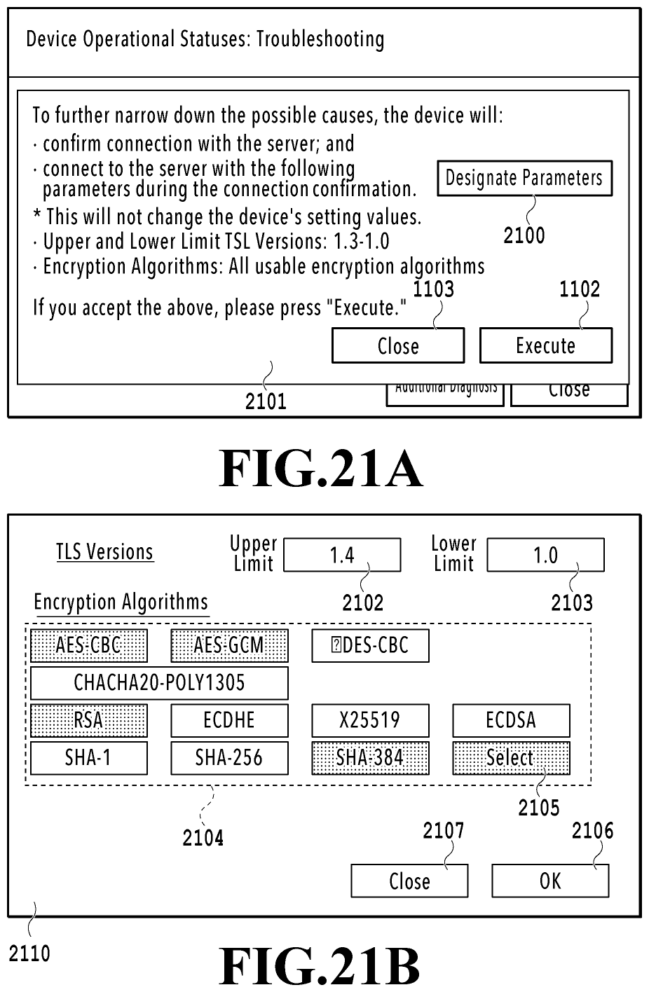

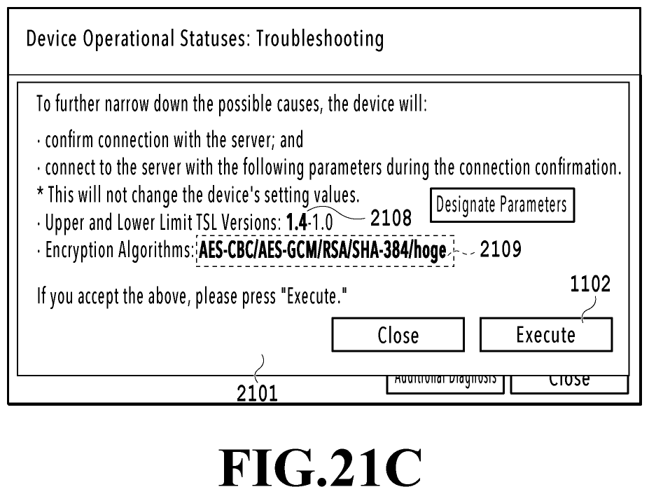

FIG. 21A is a diagram illustrating an additional diagnosis confirmation screen 2101 in the present embodiment which is displayed in S1007 in FIG. 10. The same portions as those of the additional diagnosis confirmation screen 1101 in FIG. 11B are denoted by reference signs with the same numbers. The additional diagnosis confirmation screen 2101 includes a parameter designation button 2100. The user can press the parameter designation button 2100 and select any values as the values of the parameters for the image forming apparatus 100 to connect to the mail server 110 in an additional diagnosis.

Specifically, in a case where the user presses the parameter designation button 2100, the controller unit 101 of the image forming apparatus 100 displays a parameter setting screen 2110 illustrated in FIG. 21B. The parameter setting screen 2110 is a screen on which the user can the designate values of the parameters corresponding to the exit code associated with the diagnosis target job from among user-selectable values. FIG. 21B is an example of the parameter setting screen displayed in a case where “TLS Version Mismatch” and “Missing Common Encryption Algorithm(s)” are presented as candidates of the cause of the error by an error diagnosis. FIG. 21B illustrates a screen on which the user can designate any values selected by them as the values of parameters representing TLS versions for addressing “TLS Version Mismatch” and the values of parameters representing encryption algorithms for addressing “Missing Common Encryption Algorithm(s).”

For example, in a case where the user presses an input field 2102 for the upper limit TLS version and an input field 2103 for the lower limit TLS version, the controller unit 101 displays a keyboard screen not illustrated, with which the user can designate any numeric values in the input fields 2102 and 2103.

Also, by pressing buttons representing algorithms in an algorithm list 2104 which the user wants to designate, the user can designate the algorithms corresponding to the pressed buttons. Also, in a case where the user presses an algorithm manual designation button 2105, the controller unit 101 displays a keyboard screen not illustrated, with which the user can designate any algorithm not included in the algorithm list 2104 (e.g., “hoge”).

In a case where the user presses an OK button 2106, the controller unit 101 saves the values of the parameters designated by the user, closes the parameter setting screen 2110, and displays the additional diagnosis confirmation screen 1101. For example, assume that the OK button 2106 is pressed in the state of FIG. 21B. In this case, “1.4” and “1.0” are saved as the upper and lower limit TLS versions, respectively, and “AES-CBC,” “AES-GCM,” “RSA,” “SHA-384,” and the manually designated algorithm “hoge” are saved as the encryption algorithms. Then, the controller unit 101 displays an additional diagnosis confirmation screen 2101 as illustrated in FIG. 21C and displays the designated parameters in a TLS version display region 2108 and an encryption algorithm display region 2109.

Pressing the additional diagnosis execution button 1102 in this state will change the encryption algorithms to “AES-CBC,” “AES-GCM,” “RSA,” “SHA-384,” and “hoge” in S1611 in FIG. 16B in the additional diagnosis. Pressing the additional diagnosis execution button 1102 will also change the upper and lower limit TLS versions to “1.4” and “1.0,” respectively, in S1511 in FIG. 15B in the additional diagnosis. Thus, in a case where 1.4 is added as a new TLS version but the image forming apparatus 100 has not yet recognized the latest version, for example, the user can designate 1.4 by manually inputting it.

In a case where the user presses a close button 2107, the controller unit 101 closes the parameter setting screen 2110 without saving the designated parameters, and displays the additional diagnosis confirmation screen 2101.

As described above, according to the present embodiment, in a case where the image forming apparatus 100 actually confirms its connection with the mail server 110 in an additional diagnosis, the image forming apparatus 100 can confirm the connection with the mail server 110 by using values of parameters designated as desired by the user.

### Other Embodiments

In the above-described embodiments, the processes performed by the controller unit 101 of the image forming apparatus 100 may be performed by a device outside the image forming apparatus 100. For example, a controller unit 121 in the information processing server 120 illustrated in FIG. 1, which is connected to the image forming apparatus 100 through the network 130, may perform at least some of the processes performed by the controller unit 101 in the above-described embodiments. The hardware configuration and functional arrangement of the controller unit 121 may be the same as the configuration and arrangement illustrated in FIGS. 2 and 3.

For example, the controller unit 121 of the information processing server 120 may determine the values of the parameters to be used by the image forming apparatus 100 to communicate with the mail server in a case where the image forming apparatus 100 executes a mail transmission job. The image forming apparatus 100 may set the parameters to be used to communicate with the mail server by obtaining the values determined by the controller unit 121.

Also, the controller unit 121 of the information processing server 120 may perform one or both of an error diagnosis and an additional diagnosis. For example, the controller unit 121 of the information processing server 120 may receive an error notification and perform an error diagnosis by determining the error identification information (exit code) of the diagnosis target job. Also, the controller unit 121 of the information processing server 120 may obtain the error identification information (exit code) of the diagnosis target job. Further, the controller unit 121 may obtain the values of the parameters used by the image forming apparatus 100 to communicate with the mail server 110 during the execution of the diagnosis target job. The controller unit 121 may then perform the processes of FIGS. 13B, 14B, 15B, and 16B by using the obtained data to identify the cause of the error. Specifically, the controller unit 121 may perform an additional diagnosis by comparing the result of communication with the mail server 110 with the values of the parameters changed and the values of the parameters that were set in the image forming apparatus 100 during the execution of the job.

Note that two or more of the above-described embodiments may be combined.

With the technique of the present disclosure, it is possible to more specifically diagnose the cause of a problem that occurred in a job.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-089035, filed May 31, 2024, which is hereby incorporated by reference herein in its entirety.

What is claimed is:

1. An information processing apparatus for processing transmission jobs for transmitting electronic mail, comprising:
a setting unit configured to set, in advance, a value of a parameter to be used in communication with a mail server for executing the transmission jobs;
an execution unit configured to execute the transmission jobs with the set value of the parameter;
a diagnosis unit configured to perform a diagnosis on the transmission job which failed to be executed among the transmission jobs executed by the execution unit by communicating with the mail server with a value of the parameter different from the set value of the parameter; and
an identification unit configured to identify a cause of the failure of execution of the transmission job based on the diagnosis performed by the diagnosis unit.

2. The information processing apparatus according to claim 1, further comprising
an obtaining unit configured to obtain error identification information of the transmission job which failed to be executed, wherein
the diagnosis unit sets the different value of the parameter that is based on the error identification information.

3. The information processing apparatus according to claim 2, further comprising
a management unit configured to obtain the error identification information in a case where the transmission job failed to be executed and manage the obtained error identification information in association with the transmission job.

4. The information processing apparatus according to claim 1, further comprising
a display control unit configured to display a list of executed transmission jobs, wherein
in a case where a transmission job selected from the list by a user is a transmission job which failed to be executed, the identification unit identifies a cause of the failure of the selected transmission job.

5. The information processing apparatus according to claim 1, further comprising:
an obtaining unit configured to obtain error identification information of the transmission job which failed to be executed; and
a determination unit configured to determine one or more candidates for a cause of failure of a diagnosis target transmission job based on the error identification information of the transmission job without communicating with the mail server.

6. The information processing apparatus according to claim 5, wherein
in a case where the determination unit determines the candidates, the identification unit identifies a smaller number of causes of the failure of the diagnosis target transmission job than the number of the candidates from among the candidates.

7. The information processing apparatus according to claim 5, further comprising
a display control unit configured to display a first screen displaying the candidates determined by the determination unit and allow a user to instruct an additional diagnosis via the first screen, wherein
in a case where the user instruct the additional diagnosis, the identification unit identifies the cause from among the candidates.

8. The information processing apparatus according to claim 5, further comprising
a second setting unit configured to set whether to cause the identification unit to identify the cause from among the candidates without an instruction from the user or to cause the identification unit to identify the cause from among the candidates in response to an instruction from the user.

9. The information processing apparatus according to claim 5, further comprising
a display control unit configured to display a screen for selecting a transmission job as the diagnosis target transmission job in a case where the transmission job fails to be executed.

10. The information processing apparatus according to claim 5, further comprising
a display control unit configured to display a solution to the cause identified by the identification unit from among the candidates determined by the determination unit without displaying solutions to a candidate not identified as the cause among the candidates determined by the determination unit.

11. The information processing apparatus according to claim 1, further comprising
a display control unit configured to display a setting value set in the mail server in a case where the setting value is obtained as a result of communicating with the mail server with the different value of the parameter.

12. The information processing apparatus according to claim 1, wherein
in a case where a setting value set in the mail server is obtained as a result of communicating with the mail server with the different value of the parameter, the setting unit changes the value of the parameter to be used in communication with the mail server for executing the transmission job into a value that is based on the setting value.

13. The information processing apparatus according to claim 2, further comprising
a change unit configured to change the value of the parameter that is based on the error identification information to a value that is based on an instruction from a user, wherein
the identification unit identifies the cause based on a result of communication with the mail server with the value of the parameter changed by the change unit.

14. The information processing apparatus according to claim 1, wherein
the diagnosis unit performs the diagnosis by changing a value of the parameter that is based on a target candidate selected from among a plurality of candidates for the cause of the failure of execution of the transmission job, and confirming connection with the mail server with the changed value of the parameter, and
the identification unit determines whether the candidate selected from among the plurality of candidates is the cause based on a result of the connection, and repeats the determination until all of the plurality of candidates are selected as the target candidate.

15. The information processing apparatus according to claim 1, further comprising:
a generation unit configured to generate a scanned image by scanning a document; and
a transmission unit configured to perform transmission of the scanned image in electronic mail via communication with the mail server as a transmission job.

16. An information processing method for processing transmission jobs for transmitting electronic mail, comprising:
setting, in advance, a value of a parameter to be used in communication with a mail server for executing the transmission jobs;
executing the transmission jobs with the set value of the parameter;
performing a diagnosis on the transmission job which failed to be executed among the executed transmission jobs by communicating with the mail server with a value of the parameter different from the set value of the parameter; and
identifying a cause of the failure of execution of the transmission job based on the diagnosis.

17. A non-transitory computer readable storage medium storing a program which causes a computer to perform an information processing method for processing transmission jobs for transmitting electronic mail, the information processing method comprising:
setting, in advance, a value of a parameter to be used in communication with a mail server for executing the transmission jobs;
executing the transmission jobs with the set value of the parameter;
performing a diagnosis on the transmission job which failed to be executed among the executed transmission jobs by communicating with the mail server with a value of the parameter different from the set value of the parameter; and
identifying a cause of the failure of execution of the transmission job based on the diagnosis.
